(19) United States
(12) Patent Application Publication
(10) Pub. No.: US 2026/0093515 A1
(43) Pub. Date: Apr. 2, 2026

(54) COMBINED PACKETS FOR A DISTRIBUTED DATABASE

(71) Applicant: Amazon Technologies, Inc., Seattle, WA (US)

(72) Inventors: Gourav Roy, Issaquah, WA (US); Savan Jageshbhai Popat, Seattle, WA (US); Jiahe Liu, Seattle, WA (US)

(73) Assignee: Amazon Technologies, Inc., Seattle, WA (US)

(21) Appl. No.: 18/901,827

(22) Filed: Sep. 30, 2024

(51) Int. Cl. G06F 9/455; G06F 16/27

(52) U.S. Cl. CPC G06F 9/45558; G06F 16/27; G06F 2009/45595

(57) ABSTRACT

A distributed database may use a large amount of traffic between individual components of the distributed database. The distributed database may experience latency as a result of network limitations, such as a packet per second maximum. Individual components of the distributed database hosted by a particular computing device may target individual components hosted on another particular computing device. The distributed database system may combine the packets targeting components on the other computing device to reduce the likelihood a packet per second maximum causes latency in the distributed database system.

### BACKGROUND

A distributed database may comprise a large number of individual components that communicate with one another. For example, respective ones of the individual components of a distributed database may need to communicate with other individual components to transmit or receive data. However, establishing individual network connections between the individual components may result in a large number of overall network connections being used to implement the distributed database, which may result in time costs for performing operations in the distributed database and memory costs for the individual components of the distributed database implementing the connections. Further complexity may result from the large number of connections being established, severed, and re-established. Additionally, such communications may result in a large number of packets being sent between components, which may implicate packet transmission limitations.

### BRIEF DESCRIPTION OF THE DRAWINGS

FIG. 1 is a block diagram illustrating various components of a database service and storage service that host a distributed database, according to some embodiments.

FIG. 2 is a block diagram illustrating a provider network that may implement database services that implement techniques for a connectivity layer for a distributed database, wherein the connectivity layer enables network connection sharing, according to some embodiments.

FIG. 3A is a block diagram illustrating a virtual machine server, which hosts a plurality of query processor instances and one or more network proxies, according to some embodiments.

FIG. 3B is a block diagram illustrating a storage node, which hosts a plurality of storage partitions and one or more network proxies, according to some embodiments.

FIG. 3C is a block diagram illustrating a management server, which is configured to host management instances and a network proxy, according to some embodiments.

FIG. 3D is a block diagram illustrating an adjudicator server, which hosts adjudicator instances and a network proxy, according to some embodiments.

FIG. 4A is a block diagram illustrating a query processor to storage network arranged as a complete bipartite graph (e.g., biclique), according to some embodiments.

FIG. 4B is a block diagram illustrating a query processor to adjudicator network arranged as a biclique, according to some embodiments.

FIG. 4C is a block diagram illustrating a manager to storage network arranged as a biclique, according to some embodiments.

FIG. 4D is a block diagram illustrating clusters comprising individual components of the distributed database shown in FIGS. 4A-4C, according to some embodiments.

FIG. 5 is a block diagram illustrating a query processor to storage connection layer, according to some embodiments.

FIG. 6A is a block diagram illustrating a more detailed version of a query processor to storage network proxy used to implement a query processor and storage network biclique, according to some embodiments.

FIG. 6B is a block diagram illustrating a more detailed version of a query processor to adjudicator network proxy used to implement a query processor and adjudicator network biclique, according to some embodiments.

FIG. 6C is a block diagram illustrating a more detailed version of a manager to storage network proxy used to implement a manager and storage network biclique, according to some embodiments.

FIG. 6D is a block diagram illustrating a more detailed version of a storage to query processor network proxy used to implement a query processor and storage network biclique, according to some embodiments.

FIG. 6E is a block diagram illustrating a more detailed version of an adjudicator to query processor network proxy used to implement a query processor and adjudicator network biclique, according to some embodiments.

FIG. 6F is a block diagram illustrating a more detailed version of a storage to manager network proxy used to implement a manager and storage network biclique, according to some embodiments.

FIG. 7A is a block diagram illustrating a packet that has been formed from multiple individual packets to result in a packet with a combined payload, according to some embodiments.

FIG. 7B is a block diagram illustrating an encapsulated packet with a multi-packet payload, according to some embodiments.

FIG. 7C is a block diagram illustrating metadata for a data portion of a combined packet, according to some embodiments.

FIG. 8 is a block diagram illustrating a detailed view of a shared connection used in implementing a network biclique, according to some embodiments.

FIG. 9 is a block diagram illustrating virtual machine servers that implement query processors of a distributed database (instantiated on the virtual machine servers) at a first time, such as before a cluster closes the query processor instances of the cluster, and also illustrating the virtual machine servers at a second time, such as after the cluster closes the query processor instances of the cluster, according to some embodiments.

FIG. 10 is a flowchart illustrating a method for receiving and responding to a read request in a distributed database using a connectivity layer with shared network connections, according to some embodiments.

FIG. 11 is a flowchart illustrating a method used by a network proxy for establishing a connection with a new query processor instance that has been moved between virtual machine servers, according to some embodiments.

FIG. 12 is a flowchart illustrating a method performing by network proxies for updating information relevant to determining a target storage partition for a read request, according to some embodiments.

FIG. 13 is a flowchart illustrating a method for committing a write request in a distributed database using a connectivity layer with shared network connections, according to some embodiments.

FIG. 14 is a flowchart illustrating a method for updating information relevant to determining a target adjudicator for a write request, according to some embodiments.

FIG. 15 is a flowchart illustrating a method for executing a write request in a distributed database using a connectivity layer with shared network connections, according to some embodiments.

FIG. 16 is a flowchart illustrating a method for updating information relevant to determining target storage partitions for a write request, according to some embodiments.

FIG. 17 illustrates actions of components of a distributed database system to generate and send multi-client combined packets, according to some embodiments.

FIG. 18 illustrates actions of components of a distributed database system to generate and send multi-client combined packets, according to some embodiments.

FIG. 19A is a flowchart illustrating a method for generating and sending a multi-client combined packet, according to some embodiments.

FIG. 19B is a flowchart illustrating a method for receiving and processing a multi-client combined data packet, according to some embodiments.

FIG. 20 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A distributed database may be implemented using individual components, such as virtualized computing resources, hosted by a large number of physical computing devices. The individual components may need to connect to each other in order to carry out database operations such as performing reads and writes. However, instead of establishing individual connections between the components for each communication, in some embodiments, a network proxy may be implemented on respective ones of the physical computing devices. The use of the network proxy may enable connections to be shared and re-used. Also network proxies may be used in multiple ones of the physical computing devices which may increase the speed of operation of the distributed database by maintaining application layer connections to the network proxies at the physical computing devices which host other types of components used by the distributed database (e.g. other virtual machines used to implement the distributed database). In addition to application layer connections remaining open between a given network proxy and the components implemented on the physical computing device where the network proxy resides, connections between network proxies may also be maintained open such that information can be exchanged between the network proxies in continuous streams, without the need to establish and tear down a connection each time a component of the distributed database is to communicate with another component, such as to perform a write operation or a read operation.

Some components, such as components implemented using a virtual machine, may be moved between physical computing devices, such that they occupy various physical locations over time. Without the use of a network proxy, changing the physical location of a component, such as an instance of a query processor, may require new connections to be established. The relocated component establishing new connections to all other components of the distributed database that the relocated component communicates with may cause delays in the operation of the distributed database. To reduce these delays, in some embodiments, the relocated component may instead connect to a network proxy which may be connected to other network proxies. The other network proxies may be connected to the components that the relocated component communicates with. For example, a query processor may be moved from a first physical computing device to a second physical computing device. However, a network proxy at the second physical computing device may have open connections with the same storage servers hosting the same storage partitions as the query processor was communicating with prior to being moved from the first physical computing device to the second physical computing device. Thus, once moved, the query processor may proceed to use the already established connections, established by the network proxy at the new location (e.g. second physical computing device), without a need to re-establish new connections with the storage servers, this holds even though the query processor has been moved from one physical computing device to another physical computing device.

The network proxies, which may connect to individual components of the computing device hosting the network proxy, may be part of a connectivity layer for the distributed database. The connectivity layer may enable indirect application layer connections between components of a distributed database. This connectivity layer may be implemented using a complete bipartite graph (e.g., a biclique) that connects network proxies associated with particular components, or may be implemented using another arrangement of connections. While a biclique is given as a specific example, a connectivity layer may have a different connection arrangement in some embodiments. Application layer as referred to herein refers to the application layer used by components of the distributed database, such as the application layer of the transmission control program/Internet protocol (TCP/IP) stack.

A connection that is part of a connection layer may have a limitation on an amount of packets that can be sent over the connection, for example, a maximum packets per second limitation. In some embodiments, a proxy of a computing device may determine that multiple packets are being sent to components on a particular physical computing device. The proxy may combine the packets that have the same physical computing device as a destination (e.g., they are to be sent to the same network proxy associated with the physical computing device). For example, the distributed database system may avoid the packets per second limitation as a result of proxies combining packets, which may increase the processing throughput of the distributed database and decrease the latency of the distributed database, such as due to packet per second limitations. The combined packets may include data for multiple clients. The data for a particular client may be encrypted at the time a packet leaves a component that corresponds to a cluster associated with the client, and may be decrypted by other components associated with the cluster. Clusters may have tokens provided by a secure token generation agent. Components of a cluster may identify that received data is intended to be handled by components of the cluster based on the token being used to successfully decrypt the data. Components of the distributed database not belonging to the cluster may not have a token of the cluster. Components of a cluster may be hosted on separate computing devices to reduce the likelihood that a crash at a particular computing device would impact the performance of the distributed database system.

Proxies at a sending side of the connection layer may combine data packets into a combined data packet, and proxies at a receiving side of the connection layer may separate out the combined data packet into the original data packets. The proxies at the receiving side of the connection layer may deliver the original data packets to the target components for the data packets. Data packets may include metadata which indicates a cluster of the data packet, a sending component of the data packet, and a receiving component of the data packet.

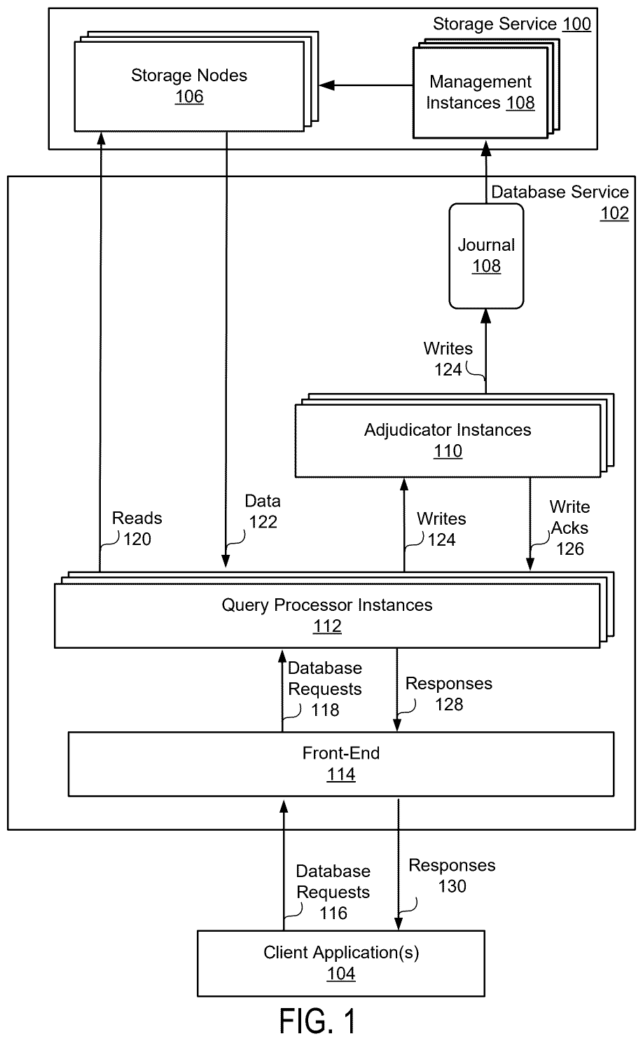

FIG. 1 is a block diagram illustrating various components of a database service and storage service that host a distributed database, according to some embodiments.

One or more client application(s) 104 may store data to one or more databases maintained by a database service 102. Client application(s) 104 may submit database requests 116 (e.g., requests that cause reads, such as queries or read-only transactions, or requests that cause writes, such as updates, inserts, deletions, or transactions that include write statements) and receive responses 130 from front-end 114.

Front-end 114 may dispatch database requests 118 to a query processor instance 112, which may parse the request and interact with different components according to the type of request. For read request, query processor instance 112 may rely upon a local cache and/or access storage nodes 106 by submitting read requests 120 for data, which are returned as data 122 and used to respond to the read. For writes, write requests 124 may be sent to an adjudicator instance 110, which may determine whether a conflict exists and if not, writes 124 to journal 108 and acknowledges the write 126 to query processor instance 112. Responses 128 may then be sent to front-end 114 for response 130 to client application(s) 104. Transactions may be applied to the database by management instance 108, at a time independent of the write acknowledgement 126, responses 128, and responses 130.

Database service 102 may implement a fleet of host computing devices which may provide, in various embodiments, a multi-tenant configuration so that different query processor instances, such as query processor instance 112 and other query processors, can be hosted on the same virtual machine, but provide access to different databases on behalf of different clients over different connections. In some embodiments, hosts systems may not be multi-tenant and a single virtual machine may implement a single query processor instance 112 which may provide access to a single database for a single client.

In some embodiments, database data for a database of database service 102 may be stored in a separate storage service 100. In some embodiments, storage service 100 may be implemented to store database data as virtual disk or other persistent storage drives. In other embodiments, embodiments, storage service 100 may store data for databases using tree structured storage and log structured storage.

For example, data may be organized in various logical volumes, segments, and pages for storage on one or more storage nodes 106 of storage service 100. For example, in some embodiments, each database may be represented by a logical volume, and each logical volume may be segmented into storage partitions over a collection of storage nodes 106. A storage partition may be an individual component that an individual query processor instance 112, for example, may communicate with. Each storage partition, which may be hosted on a particular one of the storage nodes, may contain a set of contiguous block addresses, in some embodiments.

In at least some embodiments, storage nodes 106 may provide multi-tenant storage so that data stored in a storage partition of one storage device may be stored for a different database, database user, account, or entity than data stored in another storage partition on the same storage device (or other storage devices) of the same storage node 106. Various access controls and security mechanisms may be implemented, in some embodiments, to ensure that data is not accessed at a storage node 106 except for authorized requests (e.g., for users authorized to access the database, owners of the database, etc.). For example, a cluster of database components may correspond to a particular database, and may use tokens specific to the cluster to identify and encrypt data.

In some embodiments, each storage partition may store a collection of one or more data pages and a change log (also referred to as a redo log) (e.g., a log of redo log records) for each data page that it stores. Storage nodes 106 may receive redo log records and coalesce them to create new versions of the corresponding data and/or additional or replacement log records (e.g., lazily and/or in response to a request for data or a database crash). In some embodiments, data and/or change logs may be mirrored across multiple storage nodes 106, according to a variable configuration (which may be specified by the client on whose behalf the databases is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, journal 108, which may be a logical journal, may be hosted in database service 102 that stores ordered updates to the database (e.g., to a database volume). Adjudicator instances 110 may be responsible for deciding whether transactions or writes can be committed (while following isolation rules), for working with database journal 108 to order transactions, and for ensuring that committed data is consistent. Management instances 108, which may be a logical crossbar server, may apply updates to the database stored at the storage nodes 106 from the database journal 108 as directed by the adjudicator instances 110.

Front-end 114 may implement a proxy, request router, or other load balancing feature that routes database requests to one or more query processor instances 112. For example, front-end 114 may be responsible for authenticating requests to connect to a database at a particular network endpoint and allocating a query processor instance 112 to the connection (or to a particular request such as a read or a write). The front-end 114 may maintain the connection (e.g., as a proxy) so that if different query processor instances 112 are used for different requests to the database, separate connections do not have to be established.

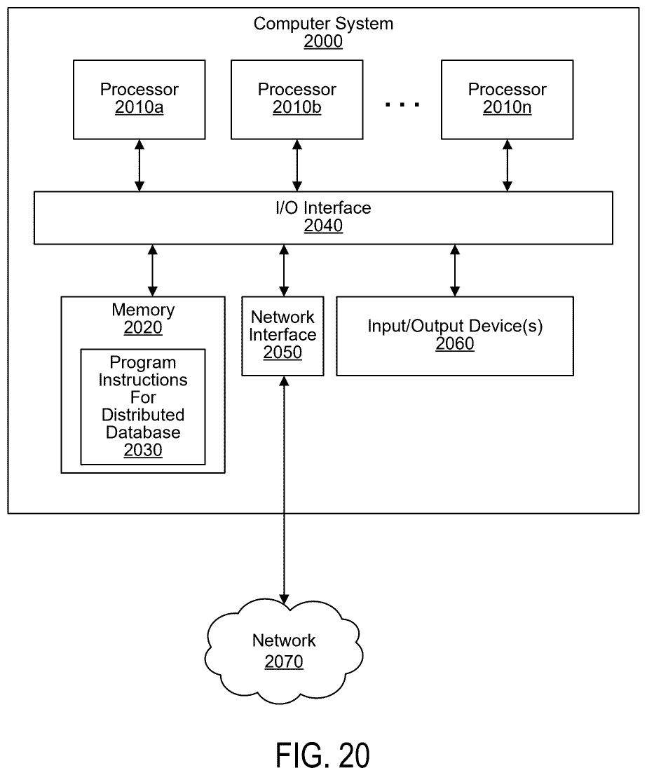

Database service 102 may implement a control plane which may manage the creation, provisioning, deletion, or other features of managing a database hosted in database service 102. For example, the control plane may monitor the performance of host computing devices (e.g., a computing system or device like computing system 2000 discussed below with regard to FIG. 20) for high workloads (e.g., heat) and move or redirect placement of database engine head node instances away from some host computing devices to avoid overburdening host computing devices. The control plane may handle various management requests, such as requests to create databases or manage databases (e.g., by configuring or modifying performance), such as by enabling a “serverless” or other automated management feature in response to a request which may cause in-place resource scaling to be enabled for that database. The control plane may direct placement of database engine head node instances on host computing devices so as to distribute workload across host computing devices to avoid failure scenarios, like out-of-memory.

Database service 102 may implement one or more different types of database systems with respective query processor instances 112 for accessing database data as part of the database. For example, database service 102 may implement various types of connection-based (e.g., having established a network connection between a database client and query processor instances 112 on a database host system) database systems which may, for instance, facilitate the performance of various operations that continue over multiple communications between the database client and the connected query processor instance 112. In at least some embodiments, database service 102 may be a relational database service that hosts relational databases on behalf of clients.

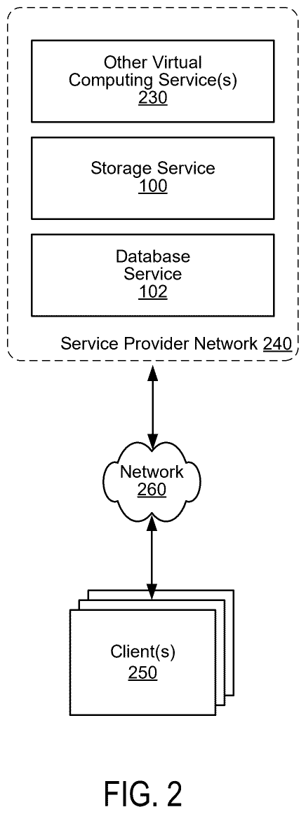

FIG. 2 is a block diagram illustrating a provider network that may implement database services that implement techniques for a connectivity layer for a distributed database, wherein the connectivity layer enables network connection sharing, according to some embodiments.

A service provider network 240 (sometimes referred to as a “cloud provider network” or “cloud”) refers to a pool of network-accessible computing resources (such as compute, storage, and networking resources, applications, and services), which may be virtualized or bare-metal. The service provider network 240 can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network 260 (e.g., the Internet, a cellular communication network) and the hardware and software in cloud provider data centers that provide those services.

A service provider network 240 can be formed as a number of regions, where a region is a separate geographical area in which the cloud provider clusters data centers. Each region can include two or more availability zones connected to one another via a private high-speed network, for example, a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the provider network via a publicly accessible network (e.g., the Internet, a cellular communication network) by way of a transit center (TC). TCs can be considered as the primary backbone locations linking users to the provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The provider network may deliver content from points of presence outside of, but networked with, these regions by way of edge locations and regional edge cache servers (points of presence, or PoPs). This compartmentalization and geographic distribution of computing hardware enables the provider network to provide low-latency resource access to users on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the provider network, which may be provisioned in user accounts.

The traffic and operations of the provider network may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

An exemplary provider network may include numerous provider network regions and so on that may include one or more data centers hosting various resource pools, such as collections of physical and/or virtualized computer servers, storage devices, networking equipment and the like (e.g., computing system 2000 described below with regard to FIG. 20), needed to implement and distribute the infrastructure and storage services offered by the provider network within the provider network regions.

As illustrated in FIG. 2, a number of clients (shown as clients 250) may interact with a service provider network 240 via a network 260. Service provider network 240 may implement respective instantiations of the same (or different) services, such as a database service 102 for a first region and a second instantiation of database service 102 for a second region, and so on. Similar arrangements may be implemented for storage service 100, as well as various other virtual computing services 230. It is noted that where one or more instances of a given component may exist, reference to that component herein may be made in either the singular or the plural. However, usage of either form is not intended to preclude the other.

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 20 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 250 may encompass any type of client configurable to submit network-based services requests to service provider network 240 via network 260, including requests for database services. For example, a given client 250 may include a suitable version of a web browser, or may include a plug-in module or other type of code module that may execute as an extension to or within an execution environment provided by a web browser. Alternatively, a client 250 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application which may interact directly with service of a region of a provider network. In some embodiments, client 250 may generate network-based services requests according to a Representational State Transfer (REST)-style web services architecture, a document-based or message-based network-based services architecture, or another suitable network-based services architecture. Although not illustrated, some clients of service provider network 240 services may be implemented within a service of the provider network (e.g., a client application of database service 102 may be implemented on one of other virtual computing service(s) 230), in some embodiments. Therefore, various examples of the interactions discussed with regard to clients 250 may be implemented for internal clients as well, in some embodiments.

In some embodiments, a client 250 (e.g., a database service client) may be provided access to network-based storage of database data to other applications in a manner that is transparent to those applications. For example, client 250 may be integrated with an operating system or file system to provide storage in accordance with a suitable variant of the storage models described herein. However, the operating system or file system may present a different storage interface to applications, such as a conventional file system hierarchy of files, directories, and/or folders. In such an embodiment, applications may not need to be modified to make use of the storage system service model, as described above. Instead, the details of interfacing to the provider network may be coordinated by client 250 and the operating system or file system on behalf of applications executing within the operating system environment.

Clients 250 may convey network-based services requests to and receive responses from a region of the provider network via network 260. In various embodiments, network 260 may encompass any suitable combination of networking hardware and protocols necessary to establish network-based communications between clients 250 and a service provider network 240. For example, network 260 may generally encompass the various telecommunications networks and service providers that collectively implement the Internet. Network 260 may also include private networks such as local area networks (LANs) or wide area networks (WANs) as well as public or private wireless networks. For example, both a given client 250 and the provider network region may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client 250 and the Internet as well as between the Internet and a provider network. It is noted that in some embodiments, clients 250 may communicate with regions of a provider network using a private network rather than the public Internet. For example, clients 250 may be provisioned within the same enterprise as a database service. In such a case, clients 250 may communicate with a provider network region entirely through a private network 260 (e.g., a LAN or WAN that may use Internet-based communication protocols but which is not publicly accessible).

Generally speaking, service provider network 240 may implement one or more service endpoints which may receive and process network-based services requests, such as requests to access a database (e.g., queries, inserts, updates, etc.) and/or manage a database (e.g., create a database, configure a database, etc.). For example, a provider network region may include hardware and/or software which may implement a particular endpoint, such that an HTTP-based network-based services request directed to that endpoint is properly received and processed. In one embodiment, a provider network region may be implemented as a server system may receive network-based services requests from clients 250 and to forward them to components of a system that implements database service 102, storage service 100, and/or another virtual computing service 230 for processing. In other embodiments, provider network region may be configured as a number of distinct systems (e.g., in a cluster topology) implementing load balancing and other request management features may dynamically manage large-scale network-based services request processing loads. In various embodiments, a provider network region may support REST-style or document-based (e.g., SOAP-based) types of network-based services requests.

In addition to functioning as an addressable endpoint for clients' network-based services requests, in some embodiments, a service provider network 240 may implement various client management features. For example, service provider network 240 may coordinate the metering and accounting of client usage of network-based services, including storage resources, such as by tracking the identities of requesting clients 250, the number and/or frequency of client requests, the size of data tables (or records thereof) stored or retrieved on behalf of clients 250, overall storage bandwidth used by clients 250, class of storage requested by clients 250, or any other measurable client usage parameter. Provider network regions may also implement financial accounting and billing systems, or may maintain a database of usage data that may be queried and processed by external systems for reporting and billing of client usage activity. In certain embodiments, provider network regions may collect, monitor and/or aggregate a variety of storage service system operational metrics, such as metrics reflecting the rates and types of requests received from clients 250, bandwidth utilized by such requests, system processing latency for such requests, system component utilization, such as the target capacity determined for individual database engine head node instances, network bandwidth and/or storage utilization, rates and types of errors resulting from requests, characteristics of storage and databases (e.g., size, data type, etc.), or any other suitable metrics. In some embodiments, such metrics may be used by system administrators to tune and maintain system components, while in other embodiments such metrics (or relevant portions of such metrics) may be exposed to clients 250 to enable such clients to monitor their usage of database service 102, storage service 100 and/or another virtual computing service 230 (or the underlying systems that implement those services).

In some embodiments, provider network regions may also implement user authentication and access control procedures. For example, for a given network-based services request to access a particular database table, a provider network region may ascertain whether the client 250 associated with the request is authorized to access the particular database table. Provider network regions may determine such authorization by, for example, evaluating an identity, password or other credential against credentials associated with the particular database table, or evaluating the requested access to the particular database table against an access control list for the particular database table. For example, if a client 250 does not have sufficient credentials to access the particular database table, the provider network region may reject the corresponding network-based services request, for example by returning a response to the requesting client 250 indicating an error condition. Various access control policies may be stored as records or lists of access control information by database services 102, storage services 100, and/or other virtual computing services 230.

Note that in many of the examples described herein, services, like database service 102 or storage service 100 may be internal to a computing system or an enterprise system that provides database services to clients 250, and may not be exposed to external clients (e.g., users or client applications). In such embodiments, the internal “client” (e.g., database service 102) may access storage service 100 over a local or private network (e.g., through an API directly between the systems that implement these services). In such embodiments, the use of storage service 100 in storing database storage structures on behalf of clients 250 may be transparent to those clients. In other embodiments, storage service 100 may be exposed to clients 250 through service provider network 240 to provide storage of database tables or other information for applications other than those that rely on database service 102 for database management. In such embodiments, clients of the storage service 100 may access storage service 100 via network 260 (e.g., over the Internet). In some embodiments, a virtual computing service 230 may receive or use data from storage service 100 (e.g., through an API directly between the virtual computing service 230 and storage service 100) to store objects used in performing computing services 230 on behalf of a client 250. In some cases, the accounting and/or credentialing services of provider network region may be unnecessary for internal clients such as administrative clients or between service components within the same enterprise.

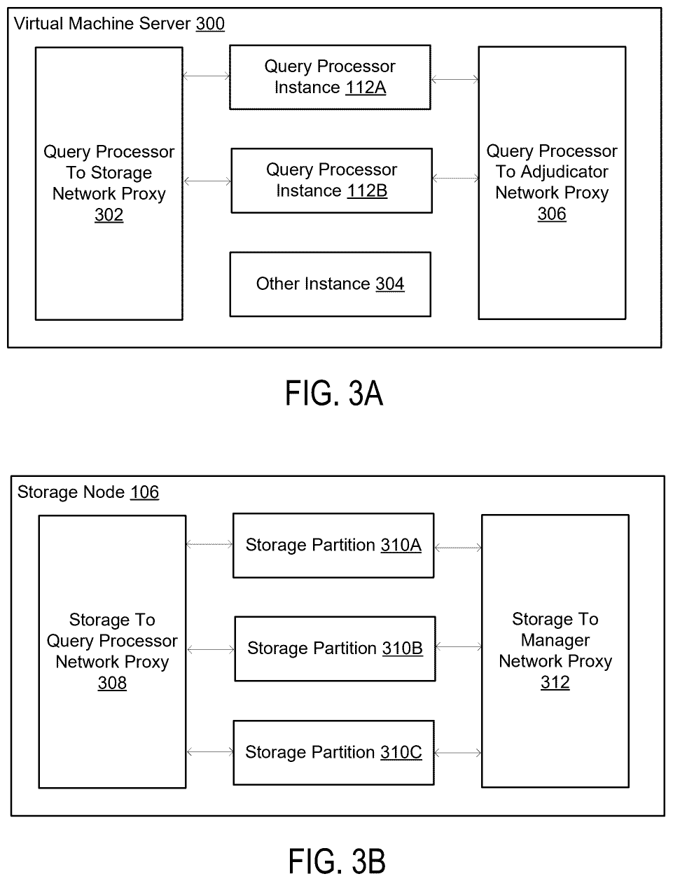

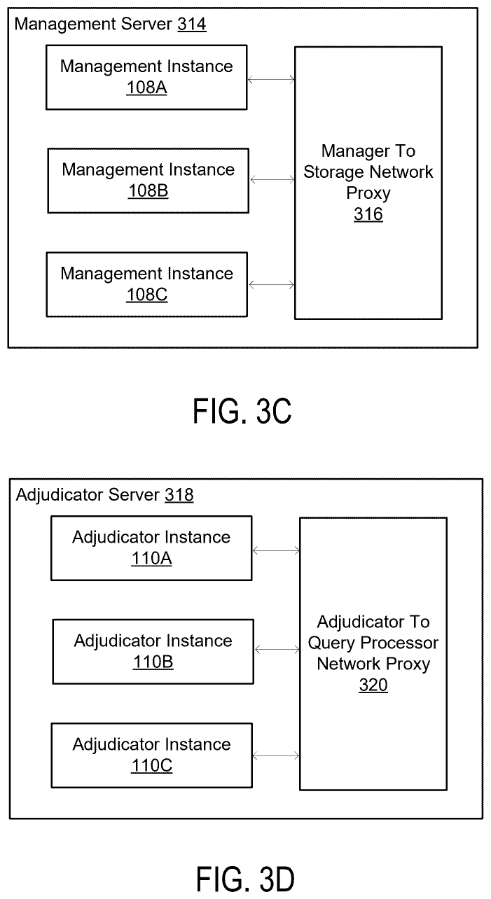

FIG. 3A is a block diagram illustrating a virtual machine server, which hosts a plurality of query processor instances and one or more network proxies, according to some embodiments.

A virtual machine server 300 may be a computing device, such as the computing system 2000 illustrated in FIG. 20. The virtual machine server 300 may host multiple virtual machines, which may implement query processor instances 112 and other instances 304. Query processor instances 112 may be query processor instances 112 involved in implementing a distributed database system as illustrated in FIG. 1. A virtual machine may begin implementing a query processor instance 112, such as query processor instance 112A or query processor instance 112B, stop implementing the query processor instance 112 and begin implementing an other instance 304 which is an instance other than a query processor instance 112. Similarly, the virtual machine may begin implementing an other instance 304, stop implementing the other instance 304, and start implementing a query processor instance 112. A query processor instance 112 may close from a particular virtual machine and be instantiated on another virtual machine, which may be another virtual machine server 300 from the virtual machine the query processor instance 112 started on. A control plane of the distributed database may instantiate and terminate query processor instances 112.

Individual query processor instances 112, such as query processor instance 112A or query processor instance 112B, may be associated with a cluster. A cluster is a set of components of a distributed database system which are used implement a given database. A particular client may be associated with one or more clusters. A query processor instance 112 may be associated with a token, which components of the cluster the query processor instance 112 belongs to may use for identification and for encryption. A secure token generation agent may vend a token to a query processing instance 112 upon the instantiation of the query processor instance 112 on a virtual machine. A query processor instance 112 may cause read requests and write requests to be executed for a distributed database. A query processor instance 112 may execute read requests by communicating with storage partitions and may cause a write request to be executed by communicating with adjudicator instances. In some embodiments, a query processor instance 112 may indirectly connect to a storage partition via a query processor to storage network proxy 302. The query processor to storage network proxy 302 may be used by multiple query processors and therefore may implement shared network connections. A query processor instance may indirectly connect to an adjudicator via a query processor to adjudicator network proxy 306, which likewise implements shared network connections.

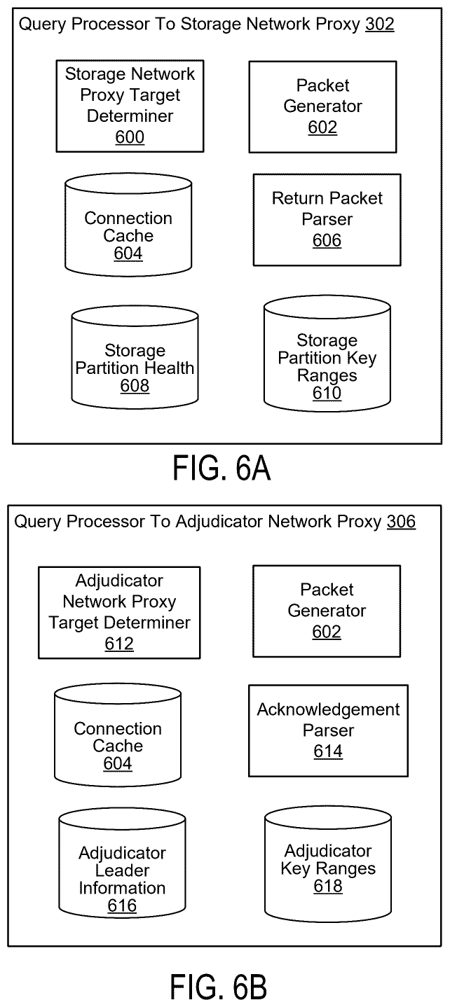

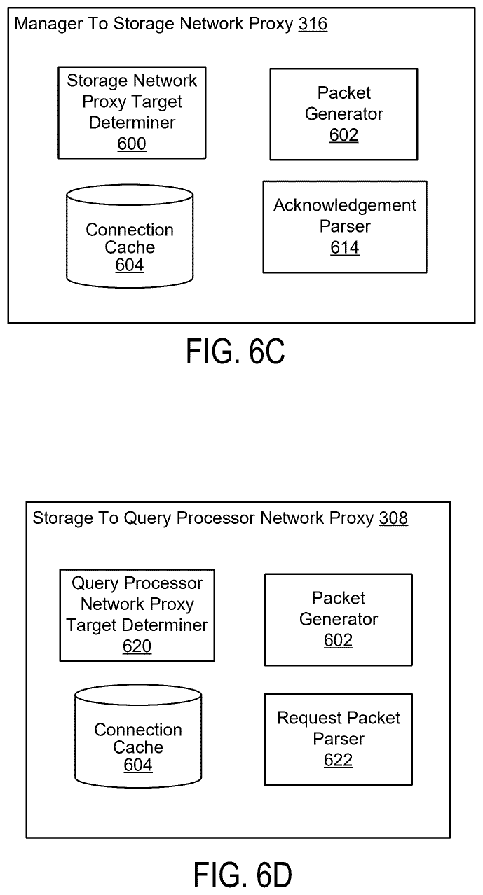

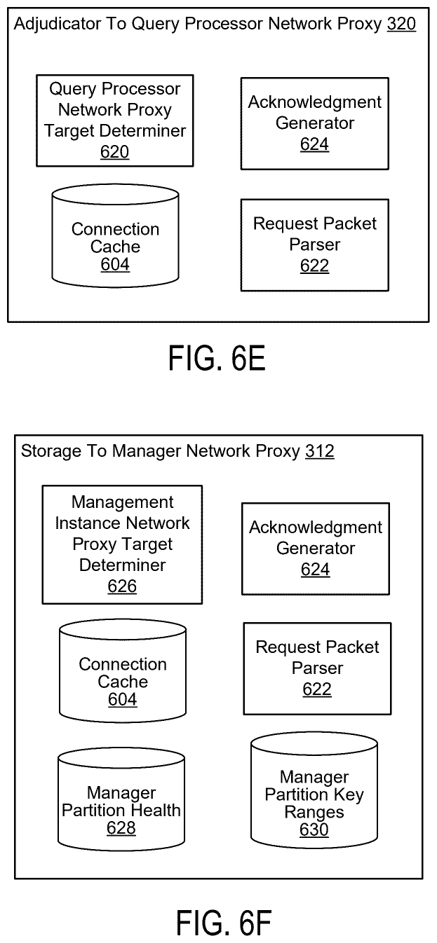

Network proxies, such as query processor to storage network proxy 302 and query processor to adjudicator network proxy 306, may be hosted on virtual machine server 300. Query processor instances 112 may connect to the network proxies via an application layer of the virtual machine server 300. Network proxies, such as query processor to storage network proxy 302 and query processor to adjudicator network proxy 306, may be implemented on a virtual machine of the virtual machine server 300, a plug-in to the virtual machine server 300, or another method of implementation. Network proxies may include particular components and may maintain particular information, as illustrated in FIGS. 6A-6F and described in relation to FIGS. 6A-6F.

Query processor to storage network proxy 302 and query processor to adjudicator network proxy 306 may connect, via an application layer, to network proxies associated with other components of the distributed database system. For example, query processor to storage network proxy 302 may connect to network proxies associated with storage nodes and query processor to adjudicator network proxy 306 may connect to network proxies associated with adjudicator instances. Network proxies may maintain connections to other network proxies during times the connections are not in use. Network proxies may connect to query processor instances via an application layer of virtual machine server 300. In some embodiments, query processor to storage network proxy 302 and query processor to adjudicator network proxy 306 may be a combined network proxy. Network proxies which are part of a connectivity layer for a distributed database may not connect to other instances 304.

FIG. 3B is a block diagram illustrating a storage node, which hosts a plurality of storage partitions and one or more network proxies, according to some embodiments.

A storage node 106 may be a computing device, such as the computing system 2000 illustrated in FIG. 20. Storage node 106 may be a storage node 106 involved in implementing a distributed database system as illustrated in FIG. 1. Storage node 106 may include storage partitions 310. Storage partitions 310 may store data which may be data for a database. Management instances may change the data stored at storage partitions 310 via write requests. Query processor instances may obtain data stored at storage partitions 310 via read requests. Storage partitions 310 may need to communicate with query processor instances and manger instances for the distributed database system to execute read requests and write requests. Storage partitions 310 may indirectly connect to query processor instances via a storage to query processor network proxy 308. Storage partitions 310 may indirectly connect to management instances via storage to management network proxy 312.

Network proxies, such as storage to query processor network proxy 308 and storage to manager network proxy 312, may connect to storage partitions 310 via an application layer of a storage node 106. Network proxies may connect, via an application layer, to network proxies associated with other components of a distributed database system. For example, storage to query processor network proxy 308 may connect to network proxies associated with query processor instances and storage to manager network proxy 312 may connect to network proxies associated with management instances. In some embodiments, storage to query processor network proxy 308 and storage to manager network proxy 312 may be a combined network proxy. Network proxies for a storage node 106, such as storage to query processor network proxy 308 and storage to manager network proxy 312, may be similar to network proxies for a virtual machine server 300 as described in relation to FIG. 3A.

FIG. 3C is a block diagram illustrating a management server, which is configured to host management instances and a network proxy, according to some embodiments.

A management server 314 may primarily host virtual machines implementing management instances 108. Management instances 108 may be management instances 108 involved in implementing a distributed database system as illustrated in FIG. 1 In some embodiments, a management server 314 may be a virtual machine server such as virtual machine server 300 illustrated in FIG. 3A. A management instance 108 may manage operation of a database, for example, a management instance 108 may push committed writes from the journal to the appropriate storage partitions and may manage database recovery in the event of a crash at one or more storage nodes. A management instance 108 may correspond to a cluster. In some embodiments, a management instance 108 may be generic to clusters and may interact with storage partitions of multiple clusters.

A management instance 108 may connect, via an application layer of the management server 314, to a manager to storage network proxy 316. The manager to storage network proxy 316 may connect to network proxies of storage nodes via an application layer. A manager to storage network proxy 316 may be similar to network proxies for a virtual machine server 300 as described in relation to FIG. 3A.

FIG. 3D is a block diagram illustrating an adjudicator server, which hosts adjudicator instances and a network proxy, according to some embodiments.

An adjudicator server 318 may primarily host virtual machines implementing adjudicator instances 110. Adjudicator instances 110 may be adjudicator instances 110 involved in implementing a distributed database system as illustrated in FIG. 1 In some embodiments, an adjudicator server 318 may be a virtual machine server such as virtual machine server 300 illustrated in FIG. 3A. Adjudicator instances 110 may pross data, such as write requests, provided by a query processor instance. Processing a write request may comprise checking write permissions and conflicts associated with the write request. A write request may be, for example, an insert, an edit, or a delete. Adjudicator instances 110 may be associated with respective clusters. A set of adjudicator instances of a cluster on a particular computing device may designate a particular adjudicator instance 110 as a leader adjudicator instance. The leader may maintain traffic and health information about the other adjudicator instances of the cluster on the computing device, and may cause write requests that an adjudicator of the cluster has processed to be written to the journal. The journal may be a durable storage, for example, the journal may be replicated across multiple service provider regions. A write request that is stored in the journal may be a committed write request. A leader adjudicator instance may enable parallel processing of write requests with an intended order by multiple adjudicator instances 110.

The adjudicator instances 110 may connect, via an application layer of the adjudicator server 318, to adjudicator to query processor network proxy 320. The adjudicator to query processor network proxy 320 may connect to network proxies associated with query processor instances via an application layer. An adjudicator to query processor network proxy 320 may be similar to network proxies for a virtual machine server 300 as described in relation to FIG. 3A.

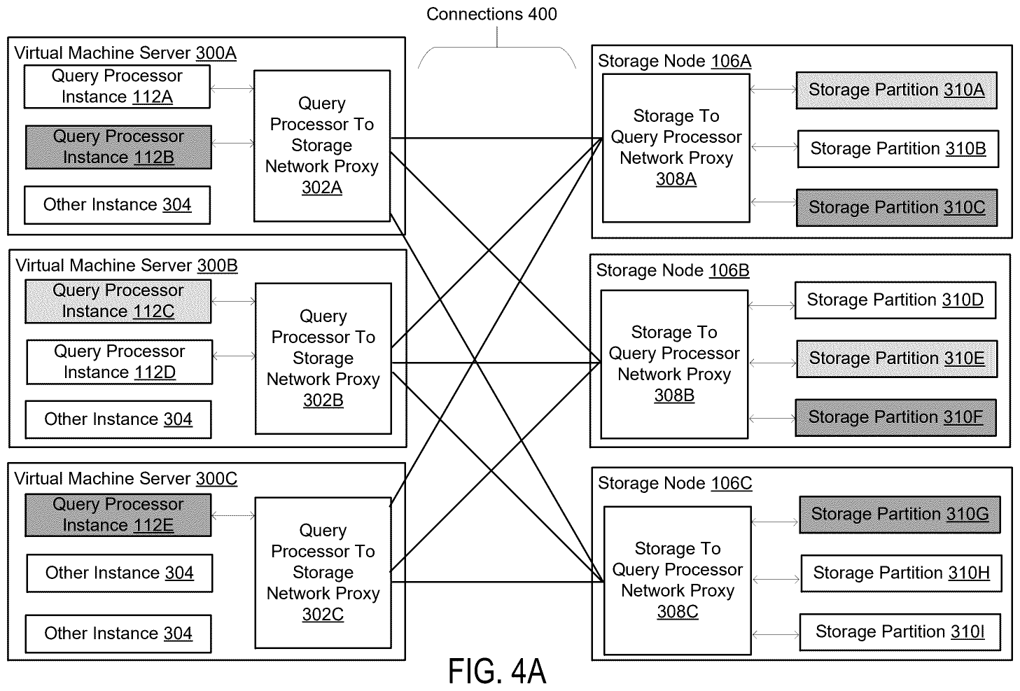

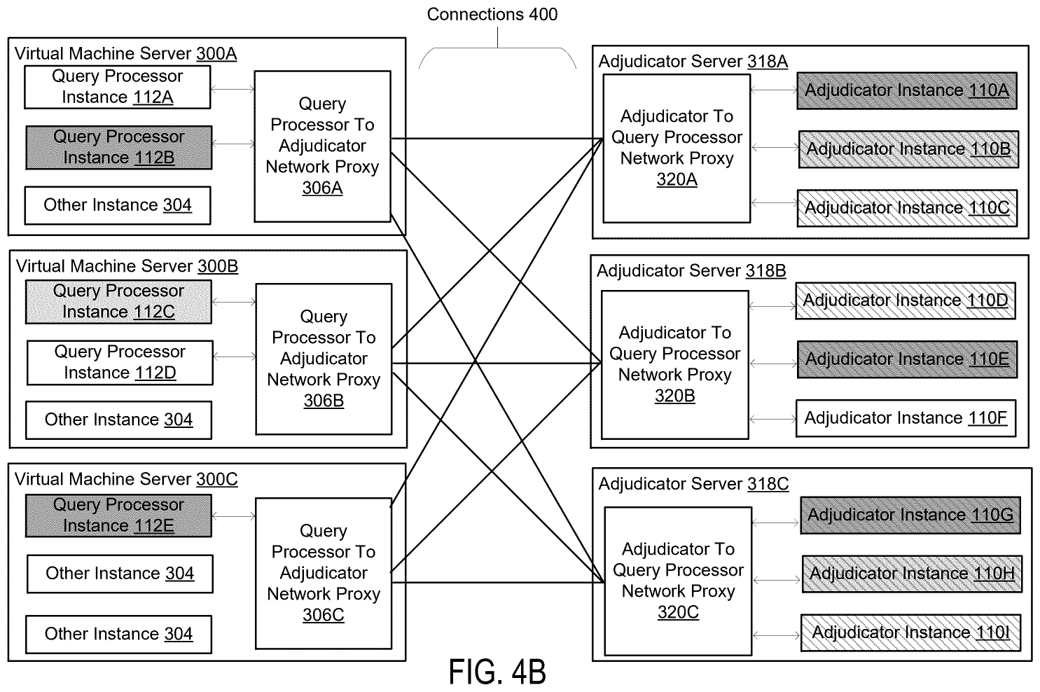

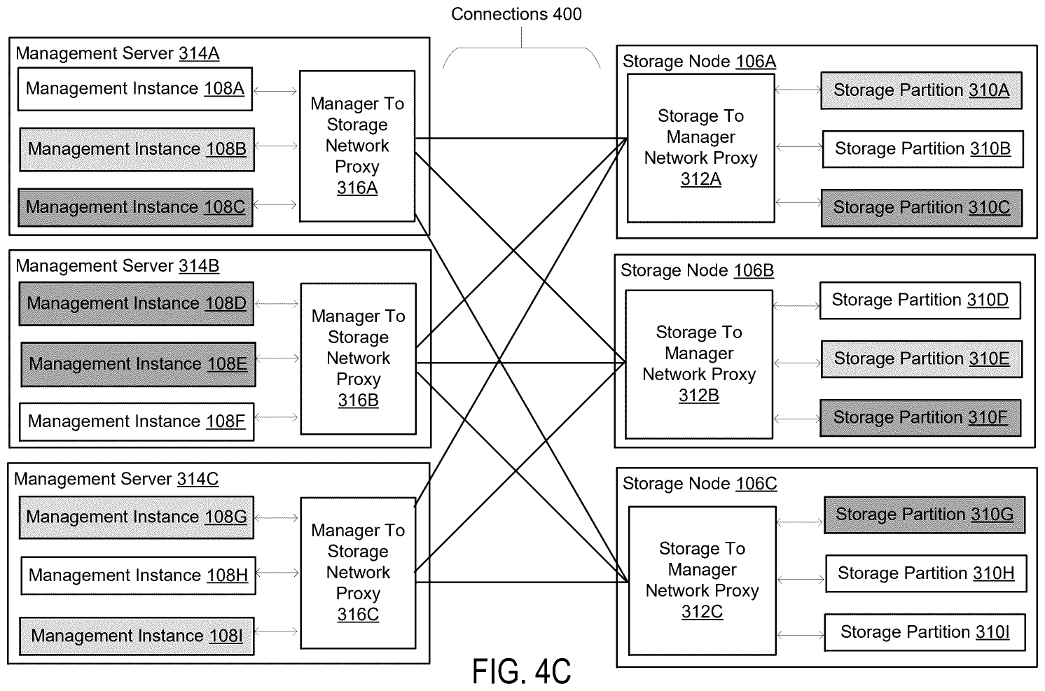

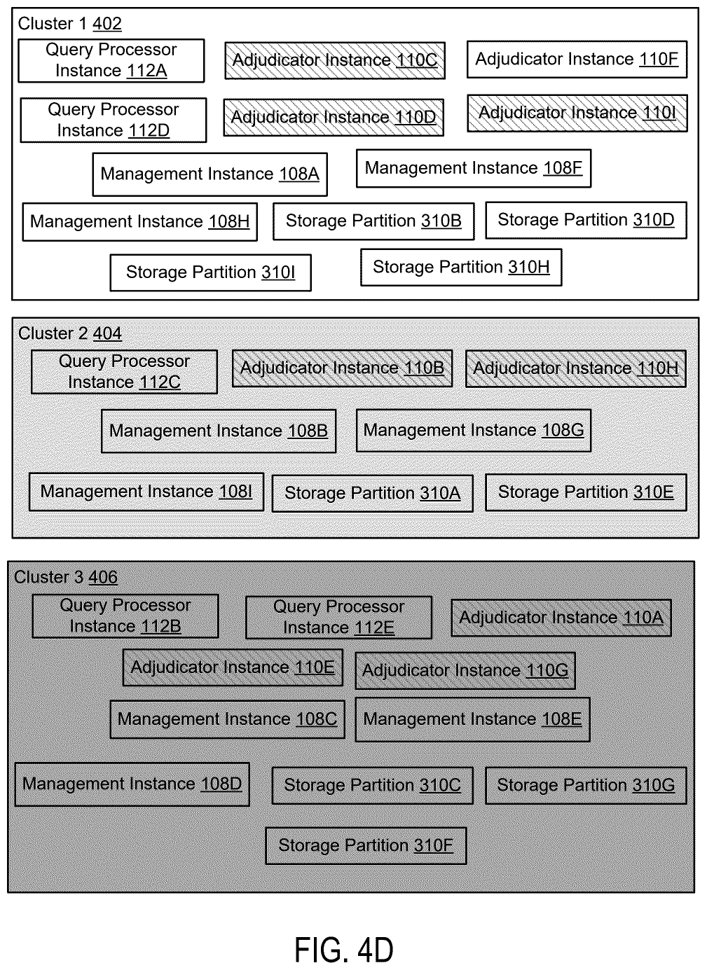

FIG. 4A is a block diagram illustrating a query processor to storage network arranged as a complete bipartite graph (e.g., biclique), according to some embodiments.

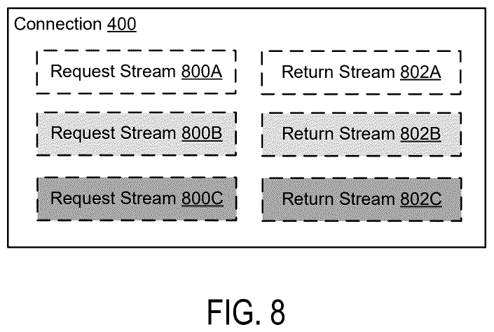

Connections 400, query processor to storage network proxies 302, and storage to query processor network proxies 308 may comprise a connection layer which enables query processor instances to maintain indirect connections to any storage partitions the query processor instances communicate with, for example, storage partitions of a query processor instance's cluster. Each illustrated query processor to storage network proxy 302 is connected, via a connection 400, to each storage to query processor network proxy 308. Connections 400 are further described in relation to FIG. 8. Query processor instances 112 are connected to the query processor to storage network proxy 302 of the query processor instances' respective virtual machine servers 300. Storage partitions 310 are connected to the storage to query processor network proxy 308 of the storage partitions' respective storage nodes 106. For each of query processor instances 112A-E, there is a connection path to each of storage partitions 310A-I. Any given query processor instance 112, with correct permissions, is able to connect to any given storage partition 310 to execute a read request. In some embodiments, connections 400 between network proxies that are not in use may be terminated.

Query processor instances 112 and storage partitions 310 may correspond to particular clusters. As an example, the color of the individual components may indicate color, as an example, query processor instance 112B and query processor instance 112E may correspond to a dark grey cluster with storage partition 310C, storage partition 310F, and storage partition 310G. Individual components of a first cluster may share permissions to interact with data for the first cluster, and individual components of a different cluster may not have permission to interact with data for the first cluster. Network proxies may be generic to clusters, for example, storage to query processor network proxy 308A may handle and distribute incoming read requests for the white, light grey, and dark grey clusters and return data responsive to the read requests for all clusters. Data passing through the connection layer of the proxies and connections 400 may be encrypted using a token that is shared by other components of the cluster. The query processor instances 112 and storage partitions 310 of a cluster may use a token that is specific to the cluster to encrypt and decrypt data being sent from one component to another.

The proxies may combine data packets which are to be sent along a single connection 400. For example, query processor to storage network proxy 302A may combine read requests from query processor instance 112A and query processor 112B that are directed to storage partition 310D and storage partition 310F respectively. Storage partition 310D and storage partition 310F are both connected to storage to query processor network proxy 308B. Storage to query processor network proxy 308B may receive a combined data packet from query processor to storage network proxy 302A containing the read requests from query processor instance 112A and query processor 112B, divide the combined data packet into the read requests, and deliver the read requests to storage partition 310D and storage partition 310F respectively.

The proxies may also combine health information and key range requests. The query processor to storage network proxies 302 may maintain health information and key range information about each of the storage partitions 310. Instead of sending an individual request directed to each storage partition 310, query processor to storage network proxy 302A may send three combined packets requesting health and key range information, one to each of storage to query processor network proxy 308A, storage to query processor network proxy 308B, and storage to query processor network proxy 308C. The storage to query processor network proxies 308 may divide the combined packets and send them to the connected storage partitions 310. The storage to query processor network proxies 308 may similarly combine the returning information from the storage partitions 310. In some embodiments, a distribution plane may maintain and provide key range information and the locations of storage partitions 310. In some embodiments, a control plane may monitor health information of storage partitions 310 for significant events, such as a crash at a storage node 106.

The query processor to storage network proxies 302 may use the health information to know which storage partitions 310 contain the most recently updated data, and may use the key range information to know which storage partitions 310 contain data responsive to particular queries. The query processor to storage network proxies 302 may determine the target destination of requests from the query processor instances 112 based on the health information and key range information.

FIG. 4B is a block diagram illustrating a query processor to adjudicator network arranged as a biclique, according to some embodiments.

Query processor instances 112 may maintain indirect connections to adjudicator instances 110 via a connection layer similarly to the connection layer between query processor instances and storage partitions described in relation to FIG. 4A. A query processor instance 112 may connect to a query processor to adjudicator network proxy 306, which may maintain connection 400 to adjudicator to query processor network proxies 320, which may be connected to adjudicator instances 110. The query processor instance 112 may send a write request to an adjudicator instance 110 via the connections 400.

The adjudicator instances 110 may correspond to clusters, for example, the light grey cluster illustrated in FIG. 4B includes query processor instance 112C, adjudicator instance 110B, and adjudicator instance 110H. A particular adjudicator 110 instance of a cluster on a server may be a leader adjudicator instance, indicated in FIG. 4B by diagonal lines. For example, adjudicator instance 110D may be the leader adjudicator instance for the white cluster on adjudicator server 318B, adjudicator instance 110E may be the leader adjudicator instance for the dark grey cluster on adjudicator server 318B, and adjudicator instance 110G may be the leader adjudicator instance for the dark grey cluster on adjudicator server 318C. Adjudicator instance 110F is illustrated as a follower instance of the white cluster on adjudicator server 318B. Each cluster for each adjudicator server may have multiple follower instances that are not illustrated in FIG. 4B. A leader adjudicator instance may send writes that an adjudicator instance 110 has checked for validity to a commit journal. The query processor instances 112 and adjudicator instance 110 of a cluster may use a token that is specific to the cluster to encrypt and decrypt data being sent from one component to another.

A query processor to adjudicator network proxy 306 may be similar to a query processor to storage network proxy 302. In some embodiments, a query processor to adjudicator network proxy 306 and a query processor to storage network proxy 302 may be the same network proxy. The query processor to adjudicator network proxy 306 may maintain health information and key range information about the adjudicator instances, and may maintain an identification of the leader adjudicator instances. Query processor to adjudicator network proxies 306 may obtain the health and key range information by requesting the information from the adjudicator instances 110 via the adjudicator to query processor network proxies 320 as described for health and key range information for storage partitions in relation to FIG. 4A. Query processor to adjudicator network proxy 306 may obtain the identification of leader adjudicator instances using a request to the adjudicator instances, or a request to a distribution plane. In some embodiments, a distribution plane may maintain and provide key range information and the locations of adjudicator instances 110. In some embodiments, a control plane may monitor health information of adjudicator instances 110 for significant events, such as a crash at an adjudicator server 318.

Query processor to adjudicator network proxies 306 may identify an adjudicator instance 110 to process a write request and send that write request to the instance and the leader adjudicator instance for that cluster. For example, query processor instance 112D may send a write request to query processor to adjudicator network proxy 306B. Query processor to adjudicator network proxy 306B may determine that the cluster corresponding to the write request is the white cluster and that the write request is for a key that is in the range for adjudicator instance 110F. The query processor to adjudicator network proxy 306B may send the write request to adjudicator to adjudicator to query processor network proxy 320B. Adjudicator to query processor network proxy 320B may send the write request to adjudicator instance 110D and adjudicator instance 110F. Adjudicator instance 110F may check the validity of the write request and return an acknowledgement to adjudicator to query processor network proxy 320B, which may return the acknowledgement to query processor to adjudicator network proxy 306B. Query processor to adjudicator network proxy 306B may return the acknowledgement to query processor instance 112D. Adjudicator to query processor network proxy 320B may also provide the acknowledgement to adjudicator instance 110D, which may cause the write request to be durably written to a commit journal.

FIG. 4C is a block diagram illustrating a manager to storage network arranged as a biclique, according to some embodiments.

Management instances 108 may maintain indirect connections to storage partitions 310 via a connection layer comprising manager to storage network proxy 316, connections 400, and storage to manager network proxy 312. A management instance 108 may connect to a manager to storage network proxy 316. the manager to storage network proxy 316 may connect to storage to manager network proxies 312. A storage to manager network proxy may connect to storage partitions 310. Management instances 108 may send committed write requests received from a journal to the storage partitions 310 via the indirect connections. Storage to manager network proxy 312 may be similar to storage to query processor network proxy 308. In some embodiments storage to manager network proxy 312 and storage to query processor network proxy 308 may be the same network proxy.

Management instances 108 may belong to particular clusters. For example, as illustrated in FIG. 4C, the white cluster includes management instance 108A, management instance 108F, management instance 108H, storage partition 310B, storage partition 310D, storage partition 310 H, and storage partition 310I. Management instances 108 of the white cluster may be able to send committed write requests to storage partitions 310 of the white cluster, and not to storage partitions 310 of other clusters. The management instances 108 and storage partitions 310 of a cluster may use a token that is specific to the cluster to encrypt and decrypt data being sent from one component to another.

Storage partitions 310 may use a subscription to identify and request writes from particular management instances 108 which correspond to a cluster and key range of the storage partition 310. A storage to manager network proxy 312 may request health information from management instances 108 to determine the management instances particular storage partitions of the storage node 106 associated with the storage to manager network proxy 312 should be subscribed to. The manager to storage network proxies 316 may maintain health and key range information about storage partitions 310. The manager to storage network proxies may request health and key range information from the storage partitions 310 via the storage to manager network proxy 312. In some embodiments, a distribution plane may maintain and provide key range information and the locations of storage partitions 310. In some embodiments, a control plane may monitor health information of storage partitions 310 for significant events, such as a crash at a storage node 106. Manager to storage network proxies 316 may use the health and key range information to identify which storage partitions 310 are to receive particular write requests.

The proxies may combine data packets which are to be sent along a single connection 400. For example, management instance to storage network proxy 108A may combine write requests from management instance 108A, management instance 108B, and management instance 108C that are directed to storage partition 310B, storage partition 310A, and storage partition 310C respectively. Storage partition 310B, storage partition 310A, and storage partition 310C are all connected to storage to manager network proxy 312A. Storage to manager network proxy 312A may receive a combined data packet from manager to storage network proxy 316A containing the write requests from management instance 108A, management instance 108B, and management instance 108C, divide the combined data packet into the read requests, and deliver the write requests to storage partition 310B, storage partition 310A, and storage partition 310C respectively. Additionally, a particular management instance 108 may combine data packets directed to storage partitions 310 of a particular storage node 106. For example, management instance 108A may combine write requests directed to storage partition 310H and storage partition 310I into a combined data packet. Storage partition 310H and storage partition 310I are both hosted by storage node 106C, so the combined data packet may be sent to storage to manager network proxy 312C, which may divide the combined data packet and deliver the original write requests to storage partition 310H and storage partition 310I.

FIG. 4D is a block diagram illustrating clusters comprising individual components of the distributed database shown in FIGS. 4A-4C, according to some embodiments.

A cluster, such as cluster 1 402, cluster 2 404, and cluster 3, may be logically isolated from other clusters. As illustrated in FIG. 4D, each cluster comprises one or more query processor instance 112, one or more adjudicator instance 110, one or more leader adjudicators (indicated by diagonal markings), one or more management instance 108, and one or more storage partition 310. Each cluster can function as a distributed database system independent of other clusters. Clusters may include varying numbers of components according to the needs of the client who owns the cluster. For example, a highly used database may have a cluster which includes relatively many query processor instances 112. As another example, a large database may have a cluster which includes relatively many storage partitions 310. Components of a cluster may encrypt data prior to sending the data between components to ensure logical isolation.

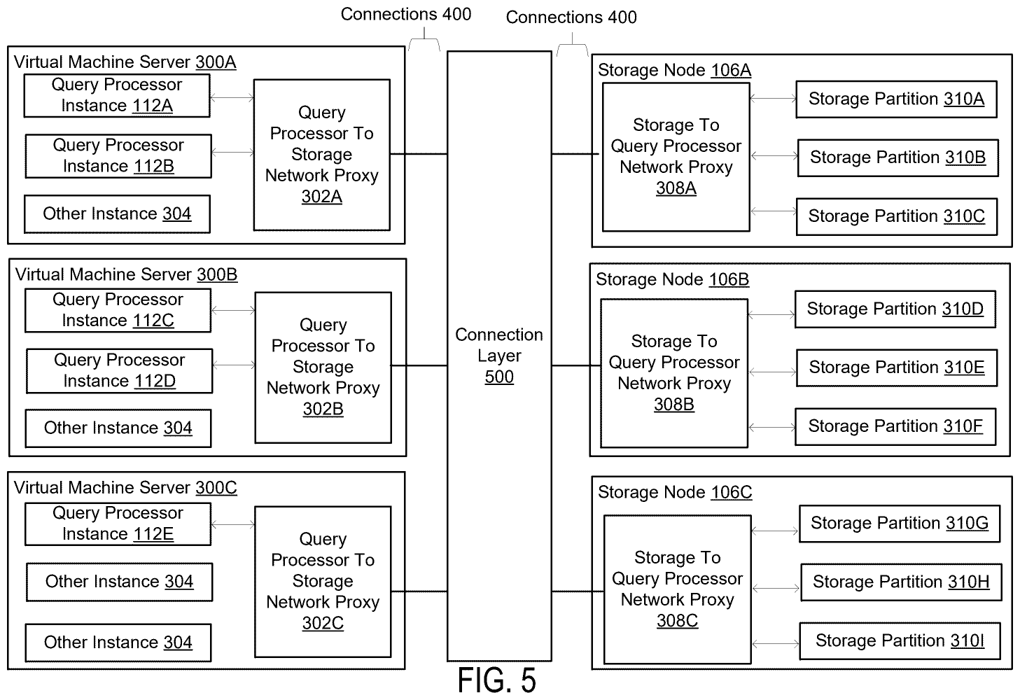

FIG. 5 is a block diagram illustrating a query processor to storage connection layer, according to some embodiments.

A connection layer 500 as shown in FIG. 5 is some set of proxies and connections 400 with which the proxies associated with computing devices hosting components of a distributed database may maintain application layer connections 400 to proxies associated with computing devices hosting different types of components of the distributed database. The connection layer 500 may enable any given network proxy to connect to any given network proxy of another type, e.g., query processor to storage network proxy 302A may connect to any storage to query processor network proxy 308. The connection layer 500 may be a single proxy that all proxies included in the distributed database connect to, as illustrated in FIG. 5, or a logical component that all proxies included in the distributed database connect to, for example, a fan arrangement of proxies. The number of total connections 400 per proxy and packets per second over a given connection 400 may be affected by the specific arrangement of proxies in the connection layer 500. An example arrangement of proxies in a connection layer 500 are illustrated in FIGS. 4A-C, where the connection layer 500 comprises the network proxies and the biclique of connections 400 between the network proxies.

FIG. 6A is a block diagram illustrating a more detailed version of a query processor to storage network proxy used to implement a query processor and storage network biclique, according to some embodiments.

A query processor to storage network proxy 302 may include elements that collectively perform the functions a query processor to storage network proxy 302 may perform in a distributed database system. For example, storage network proxy target determiner 600 may check the key number or key numbers of a read request, check which storage partitions are assigned those key numbers, check storage partition health 608 to determine which storage partitions containing duplicate data for the key numbers are the most up to date or most reliable, and designate the storage partitions as the destination for the read request. Query processor instances may encrypt read requests prior to sending the read requests to the query processor to storage network proxy 302. The storage network proxy target determiner 600 may determine information about the read request from metadata associated with the read request.

The query processor to storage network proxy 302 may have access, via a distribution plane, to the locations of the storage partitions and their associations with storage node network proxies. In some embodiments, the query processor to storage network proxy 302 may maintain location information of the storage partitions and associated storage node proxies. Connection cache 604 may maintain information about open application layer connections with query processor instances and storage node network proxies that the query processor to storage network proxy 302 may use to maintain the open connections. Connection cache 604 may provide information for returning received data to an appropriate query processor instance, for example, the cluster of a query processor instance. Connection cache 604 may provide similar information, such as the cluster of a particular storage partition, to storage network proxy determiner 600.

The packet generator 602 may attach the determined storage node network proxy destinations and storage partition destinations to the read requests. The packet generator 602 may combine read requests sharing a storage node destination or a storage partition destination into a combined packet.

The return data parser 606 may analyze packets received from the storage nodes, for example, the query processor to storage network proxy 302 may receive a combined packet containing data responsive to read requests sent from one or more of the query processor instances of the virtual machine server associated with the query processor to storage network proxy 302. The data responsive to the read requests may be encrypted differently according to the clusters of the query processor instances. The return packet parser 606 may divide the combined packet based on the metadata associated with the data responsive to the read requests and send the data responsive to the read requests to the requesting query processor instances based on an indication of the destination query processor instance in the metadata.

The network proxies may include particular elements based on the relationship between the individual components. For example, in the relationship between a query processor instance and a storage partition, the query processor instance is a consumer of data that is produced by the storage partition. A network proxy handling the query processor to storage relationship on the query processor side may use a return packet parser 606 to get the produced data to the correct query processor instance. A return packet parser 606 may use more computing resources than an acknowledgement parser, which may not handle data. A query processor instance is also a generator of requests to which a storage partition responds. A network proxy handling the query processor to storage relationship on the query processor side may refer to storage partition health 608 and storage partition key ranges 610 to determine a destination for a read request, whereas a network proxy on the storage side may determine a destination based on the origin of the read request.

FIG. 6B is a block diagram illustrating a more detailed version of a query processor to adjudicator network proxy used to implement a query processor and adjudicator network biclique, according to some embodiments.

A query processor to adjudicator network proxy 306 may include similar functional elements as a query processor to storage network proxy 302, for example, a packet generator 602 and connection cache 604. An acknowledgment parser 614 may function similarly to a return packet parser 606 in that the acknowledgement parser 614 may analyze received packets from an adjudicator and determine a destination for the acknowledgements in the packets. Acknowledgements may be brief indications of whether a particular write request is committed or failed to commit.

An adjudicator network proxy target determiner 612 may determine destination adjudicator instances for write requests based on metadata associated with the write requests. The adjudicator network proxy target determiner 612 may use adjudicator key ranges 618 to determine which adjudicator instance is responsible for the write request, and may use the adjudicator leader information 616 to determine which adjudicator instance is to receive a copy of the write request to commit in the journal. The query processor to adjudicator network proxy 306 may receive location information for adjudicator instances, including associated adjudicator network proxy information, from a distribution plane.

A query processor instance is a producer of data in the form of write requests to an adjudicator instance. A query process instance is also a generator of a request to which the adjudicator instance responds. A network proxy on the query processor side of the query processor and adjudicator relationship uses an acknowledgement parser 614 to receive acknowledgements that write requests have been handled and an adjudicator leader information 616 and adjudicator key ranges 618 to determine destinations for the write requests.

FIG. 6C is a block diagram illustrating a more detailed version of a manager to storage network proxy used to implement a manager and storage network biclique, according to some embodiments.

A manager to storage network proxy 316 may include elements similar to a query processor to storage network proxy 302 and a query processor to adjudicator network proxy 306. A manager to storage network proxy 316 is a producer of data in the form of write requests to a storage partition, and is a generator of requests to execute the write requests to a storage partition. As a generator of requests to storage partitions, the manager to storage network proxy 316 may include a storage network proxy target determiner 600, which may determine which storage partitions are subscribed to particular management instances. The connection cache 604 may include information regarding which particular storage partitions are subscribed to which particular management instances. Manager to storage network proxy 316 may also include components similar to storage partition health 608, and storage partition key ranges 610. As a producer of information, the manager to storage network proxy 316 may include an acknowledgement parser 614. The connection cache 604 and packet generator 602 may function as described in association with FIG. 6A.

FIG. 6D is a block diagram illustrating a more detailed version of a storage to query processor network proxy used to implement a query processor and storage network biclique, according to some embodiments.

A storage partition receives and responds to requests for data from a query processor instance. A storage to query processor network proxy 308 may use a request packet parser 622 to analyze received packets from a query processor network proxy. A request packet parser 622 may divide received combined packets into read requests based on metadata associated with the read requests and provide the read requests to the destination storage partitions. A query processor network proxy target determiner 620 may determine return query processor network proxy destinations and return query processor instance destinations based on the origins of the read requests. The connection cache 604 and packet generator 602 may function as described in association with FIG. 6A.

FIG. 6E is a block diagram illustrating a more detailed version of an adjudicator to query processor network proxy used to implement a query processor and adjudicator network biclique, according to some embodiments.

An adjudicator receives requests to process data from a query processor instance. An adjudicator to query processor network proxy 320 may use a request packet parser 622 as described in association with FIG. 6D. A query processor network proxy target determiner 620 may also function as described in association with FIG. 6D. The connection cache 604 may function as described in association with FIG. 6A. An acknowledgement generator 624 may obtain the results of processing from adjudicator instance, such as an acknowledgement a write is committed or an acknowledgement a write is failed, and transmit the results as directed by the query processor network proxy target determiner 620. An acknowledgement generator 624 may be simpler than a packet generator 602, and may not handle encrypted data.

FIG. 6F is a block diagram illustrating a more detailed version of a storage to manager network proxy used to implement a manager and storage network biclique, according to some embodiments.

A storage partition receives requests to execute write requests from a manager. A storage to manager network proxy may include some elements similar to an adjudicator to query processor network proxy 320. The connection cache 604 may function as described in association with FIG. 6A. A request packet parser 622 may function as described in association with FIG. 6D. An acknowledgement generator 624 may function as described in association with FIG. 6E. A management instance network proxy target determiner 626 may determine manager network proxy destinations and management instance destinations for the acknowledgements based on the origins of write requests as determined by the request packet parser 622.

The storage to manager network proxy 312 may also determine the management instances particular storage partitions are to be subscribed to in order to receive the write requests for the cluster and key range of the storage partition. The storage to manager network proxy 312 may maintain manager partition health 628 and manger partition key ranges 630 to manage the storage partitions' subscriptions to particular management instances.

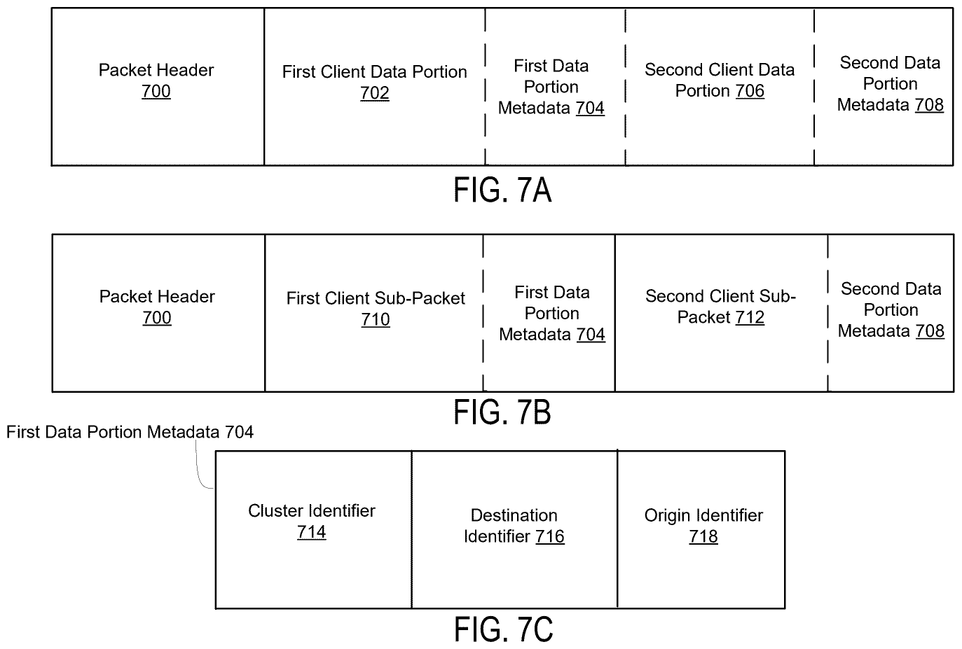

FIG. 7A is a block diagram illustrating a packet that has been formed from multiple individual packets to result in a packet with a combined payload, according to some embodiments.

A proxy may combine data by placing data from data packets, such as read requests, write requests, and data responsive to read requests, into the payload of a combined packet generated by the proxy. The proxy may generate a packet header 700 indicating the proxy as an origin and another proxy as a destination. The data from data packets sent from components of the distributed database system may be associated with metadata which may include the cluster of a particular data portion, the originating component of the particular data portion, and the destination component of the particular data portion. In some embodiments, the proxy may determine the destination component and add the destination component to the metadata.

First client data portion 702 may be encrypted data originated by a component of a distributed database such as a query processor instance, a management instance, or a storage partition. The component of the distributed database may correspond to a cluster, which may be associated with a particular client. The data portion which originated from the component may also be associated with the cluster, and may be decrypted by another component of the cluster which has a token associated with the cluster. First data portion metadata 704 may be metadata associated with first client data portion 702, and is illustrated in more detail in FIG. 7C. Second client data portion 706 may be data which originated from a different component of the distributed database, which is associated with the same proxy and a different cluster and client than the component which originated the first client data portion 702. Second data portion metadata 708 may be metadata associated with second client data portion 706. The proxy may be unable to decrypt data and may securely generate a packet which has a payload that contains first client data portion 702 and second client data portion 706 as illustrated in FIG. 7A.

FIG. 7B is a block diagram illustrating an encapsulated packet with a multi-packet payload, according to some embodiments.

First client sub-packet 710 and second client sub-packet 712 may be packets that are substantially the same as packets sent to a proxy by components of the distributed database system. First client sub-packet 710 and second client sub-packet 712 may respectively include first data portion metadata 704 and second data portion metadata 708. The metadata may include information indicating destination components of the distributed database system that are associated with the same destination proxy. The proxy may encapsulate the sub-packets in a combined packet which indicates the proxy as an origin and the destination proxy as a destination in the packet header 700.

FIG. 7C is a block diagram illustrating metadata for a data portion of a combined packet, according to some embodiments.

Metadata for data portions may be consistent for the type of packets a proxy sends or receives. Metadata, such as first data portion metadata 704 may include cluster identifier 714, destination identifier 716, and origin identifier 718. Cluster identifier 714 may indicate what cluster the data is associated with, and a receiving component may use cluster identifier 714 in addition to or as an alternative to identifying that the data is intended for the receiving component's cluster by decrypting the data with a token associated with the cluster and checking that decryption was successful. Destination identifier 716 may indicate a destination component. A sending proxy may use the destination identifier 716 to select the packet for inclusion in a combined packet. Origin identifier 718 may indicate an origin component. A receiving proxy may retain the information about the origin component to direct return packets. Metadata may also include other information for directing the data, for example, key ranges associated with a read request or write request. A proxy or a receiving component may verify a data packet by checking that the cluster identifier 714, destination identifier 716, and origin identifier 718 correspond to the same cluster.

FIG. 8 is a block diagram illustrating a detailed view of a shared connection used in implementing a network biclique, according to some embodiments.

A connection 400 between a component of a distributed database system and a proxy or between two proxies of a distributed database system may include one or more streams of information. A stream may comprise data that is sent across the application layer connection. Streams 800 and 802 may be separated according to directionality (such as between request streams 800 and return streams 802) and may be separated according to clusters (such as between request stream 800A, request stream 800B, and request stream 800C). In some embodiments, request streams 800 may be combined and return streams 802 may be combined. In some embodiments, streams may be bi-directional so a request stream 800 is the same as a return stream 802.

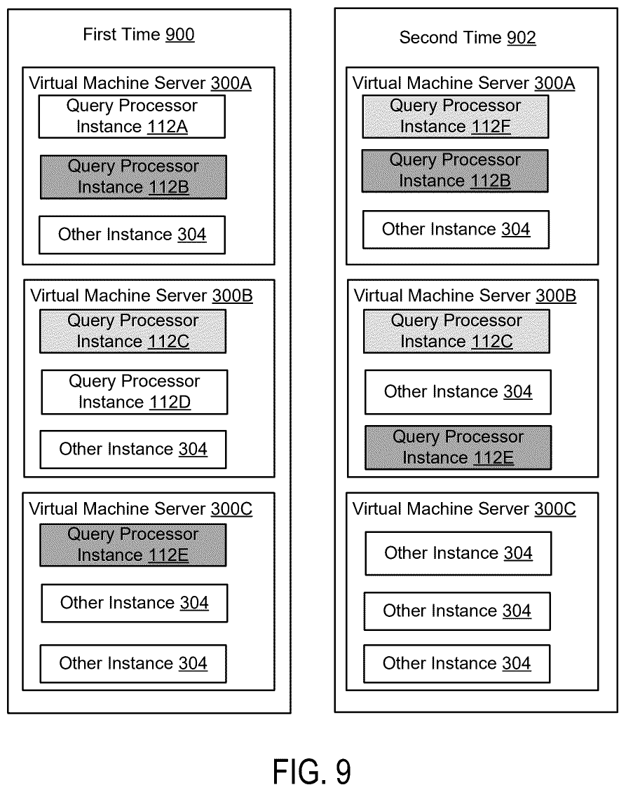

FIG. 9 is a block diagram illustrating virtual machine servers that implement query processors of a distributed database (instantiated on the virtual machine servers) at a first time, such as before a cluster closes the query processor instances of the cluster, and also illustrating the virtual machine servers at a second time, such as after the cluster closes the query processor instances of the cluster, according to some embodiments.

At the first time 900, query processor instances 112 may be instantiated in a particular configuration, as illustrated in FIG. 9. The configuration of query processor instances 112 may change so that query processor instances 112 are instantiated differently at a second time 902. For example, between the first time 900 and the second time 902, the white cluster stopped operation of query processor instances 112, including specifically query processor instance 112A and query processor instance 112D. The client associated with the white cluster may have finished updating and using the distributed database between first time 900 and second time 902.

Query processor instance 112A disconnected from the network proxy associated with virtual machine server 300A and closed. The virtual machine hosting query processor instance 112A was replaced with a new query processor instance 112F. Query processor instance 112F is associated with light grey cluster. Light grey cluster may have added query processor instance 112F in response to an increase in the number of read requests or write requests for the light grey cluster. Query processor instance 112F, when instantiated on the virtual machine, connected to the network proxy associated with virtual machine server 300A. Query processor instance 112D disconnected from the network proxy associated with virtual machine server 300B and closed. The virtual machine hosting query processor instance 112D was replaced with an other instance 304 not related to the distributed database. Other instance 304 did not connect to the network proxy associated with virtual machine server 300B when instantiated.

Query processor instance 112E moved from a virtual machine on virtual machine server 300C to a virtual machine on virtual machine server 300B. Query processor instance 112E disconnected from the network proxy associated with virtual machine server 300C and closed, and was instantiated on virtual machine server 300B. Query processor instance 112E connected to the network proxy associated with virtual machine server 300B and resumed operation. A distribution plane of the distributed database may have informed proxies of the distributed database of the change. Virtual machine server 300C may be unassociated with the distributed database system, or may begin implementing another type of component of the distributed database system, for example adjudicator instances or management instances.

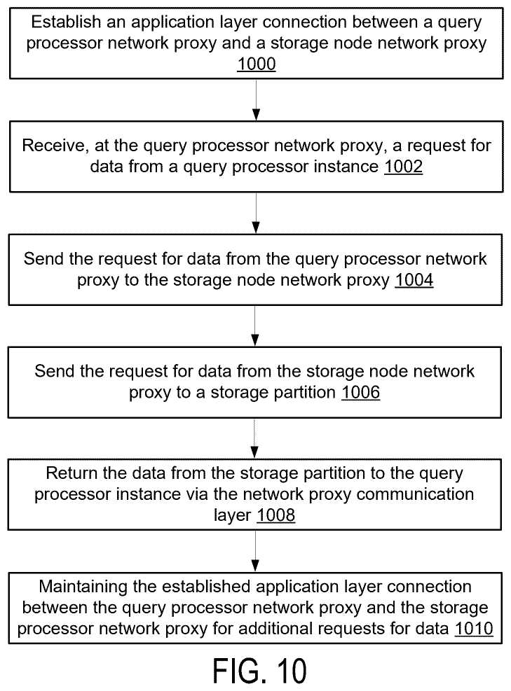

FIG. 10 is a flowchart illustrating a method for receiving and responding to a read request in a distributed database using a connectivity layer with shared network connections, according to some embodiments.

At 1000, a query processor to storage network proxy may establish an application layer connection to a storage to query processor network proxy. At 1002, the query processor to storage network proxy may receive a request for data from a query processor instance. At 1004, the query processor to storage network proxy may send the request for data to the storage to query processor network proxy. At 1006, the storage to query processor network proxy may send the request for data to a storage partition. At 1008, the storage to query processor network proxy may return the data received from the storage partition to the query processor to storage network proxy, which may send the data to the requesting query processor instance. At 1010, the query processor to storage network proxy and storage to query processor network proxy may maintain the established application layer connection for additional requests for data.

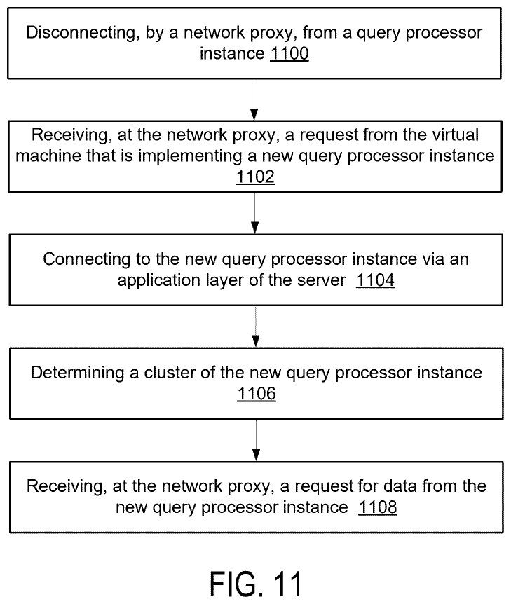

FIG. 11 is a flowchart illustrating a method used by a network proxy for establishing a connection with a new query processor instance that has been moved between virtual machine servers, according to some embodiments.

At 1100, a query processor to storage network proxy may disconnect from a query processor instance. The virtual machine of the query processor instance may currently not be implementing the query processor instance. At 1102, the query processor to storage network proxy may receive a connection request from the virtual machine of the query processor instance that is currently implementing a new query processor instance. The new query processor instance may be associated with a different cluster than the disconnected query processor instance. The new query processor instance may be implemented by a virtual machine of the physical computing device the network proxy is associated with. The new query processor instance may have been requested by a client for using or changing data stored in a given database, or the new query processor instance may have been allocated to the given database as a result of a high amount of traffic for the given database. The new query processor instance may be attempting to establish a connection with the network proxy. The network proxy may be maintaining open connections with other network proxies which are associated with individual components the new query processor instance is to interact with to implement the given database, e.g., components that are associated with the cluster of the new query processor instance.

At 1104, the query processor to storage network proxy may connect to the new query processor instance via an application layer of the server. At 1106, the query processor to storage network proxy may determine a cluster of the new query processor instance. At 1108, the query processor to storage network proxy may receive a request for data from the new query processor instance.

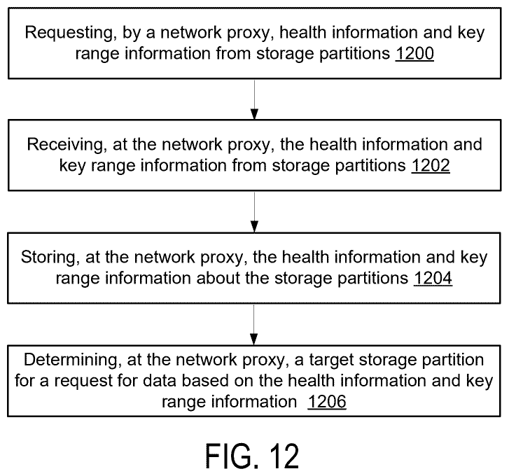

FIG. 12 is a flowchart illustrating a method performing by network proxies for updating information relevant to determining a target storage partition for a read request, according to some embodiments.

At 1200, a query processor to storage network proxy may request health information and key range information from storage partitions. The query processor to storage network proxy may use the health information to determine which storage partition of a set of storage partitions maintaining duplicate data has been updated most recently. The query processor to storage network proxy may use the health information to determine whether a given storage partition is currently active and capable of processing a read request. The query processor to storage network proxy may collect health information from all storage partitions multiple times per second. Compared to a distributed database system in which an individual query processor instance would connect to individual storage partitions and collect and maintain health information about the storage partitions, a distributed database system in which a network proxy for the individual query processor instances collects and maintains health information about the storage partitions may have less health information related network traffic, by an amount of traffic that is similar to the ratio of query processor instances to network proxies. A network proxy may combine health information requests directed to storage partitions associated with a single different network proxy into a combined health information request packet to reduce the number of packets sent over a particular connection. At 1202, the query processor to storage network proxy may receive the health information and key range information from storage partitions. At 1204, the query processor to storage network proxy may store the health information and key range information about the storage partitions. At 1206, the query processor to storage network proxy may determine a target storage partition for a request for data based on the health information and key range information.

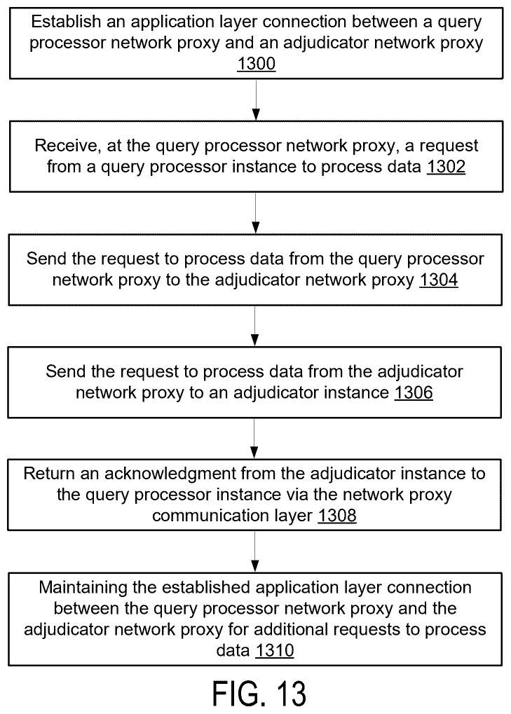

FIG. 13 is a flowchart illustrating a method for committing a write request in a distributed database using a connectivity layer with shared network connections, according to some embodiments.

At 1300, a query processor to adjudicator network proxy may establish a connection with an adjudicator to query processor network proxy. At 1302, the query processor network proxy may receive a request from a query processor instance to process data that is to be stored. At 1304, the query processor network proxy may send the request to process data to the adjudicator to query processor network proxy. At 1306, the adjudicator to query processor network proxy may send the request to process data to an adjudicator instance. At 1308, the adjudicator to query processor network proxy may return an acknowledgement received from the adjudicator instance to the query processor instance, which may further return the acknowledgement to the query processor instance. At 1310, the query processor to adjudicator network proxy and adjudicator to query processor network proxy may maintain the established application layer connection for additional requests to process data.

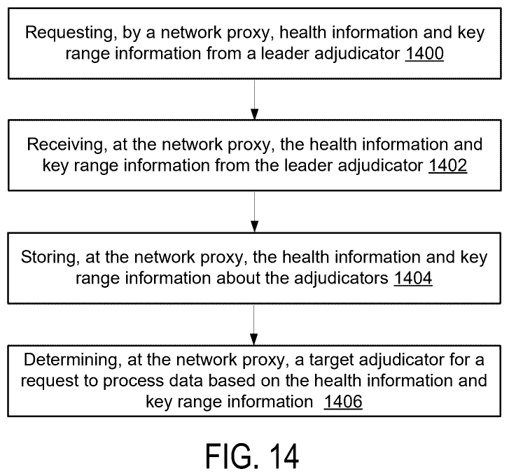

FIG. 14 is a flowchart illustrating a method for updating information relevant to determining a target adjudicator for a write request, according to some embodiments.

At 1400, a query processor to adjudicator network proxy may request health information from a leader adjudicator. The query processor to storage network proxy may use the health information to determine whether a particular adjudicator is currently active and capable of processing a write request. Compared to a distributed database system in which an individual query processor instance would connect to individual adjudicators and collect and maintain health information about the adjudicators, a distributed database system in which a network proxy for the individual query processor instances collects and maintains health information about the adjudicators may have less health information related network traffic, by an amount of traffic that is similar to the ratio of query processor instances to network proxies. A network proxy may combine health information requests directed to adjudicators that are associated with a single different network proxy into a combined health information request packet to reduce the number of packets sent over a particular connection. At 1402, the query processor to adjudicator network proxy may receive the health information from the leader adjudicator. At 1404, the query processor to adjudicator network proxy may store the health information and key range information about the adjudicators. At 1406, the query processor to adjudicator network proxy may determine a target adjudicator to process a request to store data based on the health information and key range information.

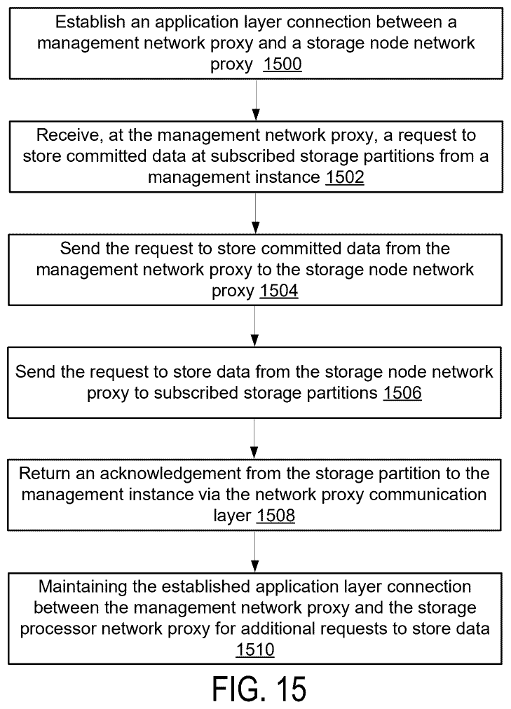

FIG. 15 is a flowchart illustrating a method for executing a write request in a distributed database using a connectivity layer with shared network connections, according to some embodiments.

At 1500, a manager to storage network proxy may establish an application layer connection with a storage to manager network proxy. At 1502, the manager to storage network proxy may receive a request to store committed data at subscribed storage partitions from a management instance. At 1504, the manager to storage network proxy may send the request to store committed data to the storage to manager network proxy. At 1506, the storage to manger network proxy may send the request to store data to subscribed storage partitions. At 1508, the storage to manger network proxy may return an acknowledgement received from a particular storage partition to the manager to storage network proxy, which may further return the acknowledgement to the management instance. At 1510, the manager to storage network proxy and storage to manager network proxy may maintain the established application layer connection for additional requests to store data.

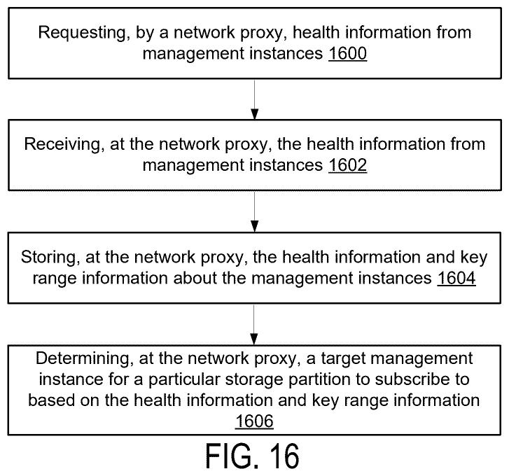

FIG. 16 is a flowchart illustrating a method for updating information relevant to determining target storage partitions for a write request, according to some embodiments.

At 1600, a storage to manager network proxy may request health information from management instances. The storage to manager network proxy may use the health information to determine whether a particular management instance is currently active and capable of sending a write request. A manager may be involved in a restoration process for storage partitions that are involved in a crash. Compared to a distributed database system in which an individual storage partition would connect to individual management instances and collect and maintain health information about the management instances, a distributed database system in which a network proxy for the individual storage partitions collects and maintains health information about the management instances may have less health information related network traffic, by an amount of traffic that is similar to the ratio of storage partitions to network proxies. A network proxy may combine health information requests directed to management instances associated with a single different network proxy into a combined health information request packet to reduce the number of packets sent over a particular connection. At 1602, the storage to manager network proxy may receive the health information from the management instances. At 1604, the storage to manager network proxy may store the health information and key range information about the management instances. At 1606, the storage to manager network proxy may determine a target management instance for a particular storage partition to subscribe to based on the health information and key range information.

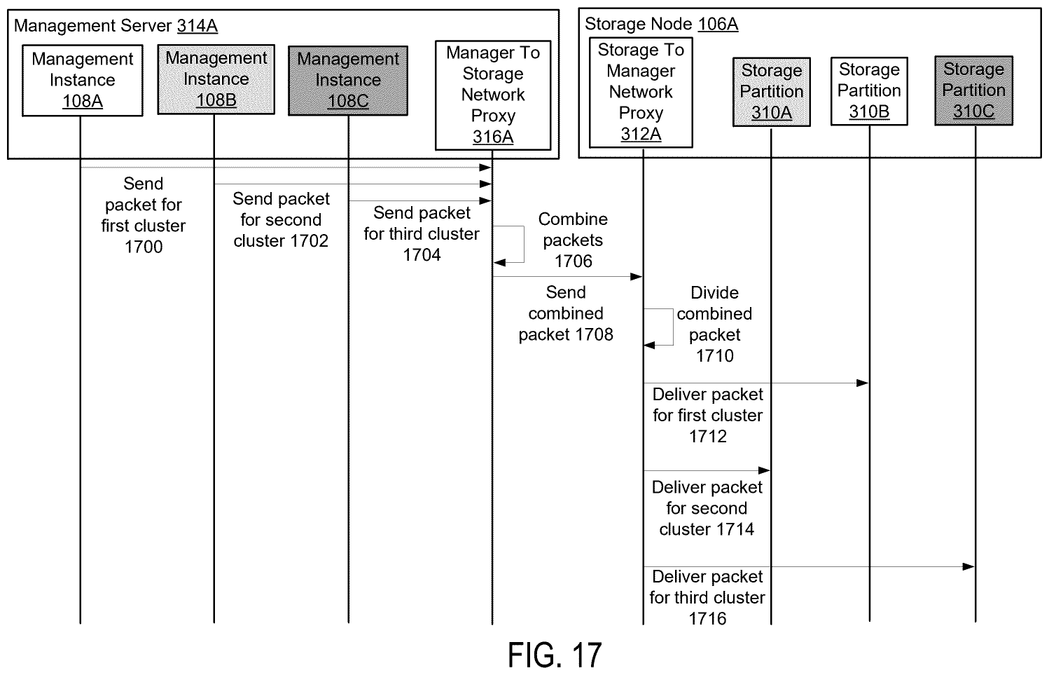

FIG. 17 illustrates actions of components of a distributed database system to generate and send multi-client combined packets, according to some embodiments.

At 1700, management instance 108A, which may be associated with a first cluster, may send a packet that is associated with the first cluster to manager to storage network proxy 316A. At 1702, management instance 108B, which may be associated with a second cluster, may send a packet that is associated with the second cluster to manager to storage network proxy 316A. At 1704, management instance 108C, which may be associated with a third cluster, may send a packet that is associated with the third cluster to manager to storage network proxy 316A.

At 1706, manager to storage network proxy 316A may combine the packets received from the management instances 108 into a combined packet. At 1708, the manager to storage network proxy 316 may send the combined packet to storage to manager network proxy 312A. At 1710, storage to manager network proxy 312A may receive the combined packet and divide the combined packet into packets similar to the packets sent from the management instances 108.

At 1712, storage to manager network proxy 312A may deliver the packet associated with the first cluster to storage partition 310B, which may be associated with the first cluster. At 1714, storage to manager network proxy 312A may deliver the packet associated with the second cluster to storage partition 310A, which may be associated with the second cluster. At 1716, storage to manager network proxy 312A may deliver the packet associated with the third cluster to storage partition 310C, which may be associated with the third cluster.

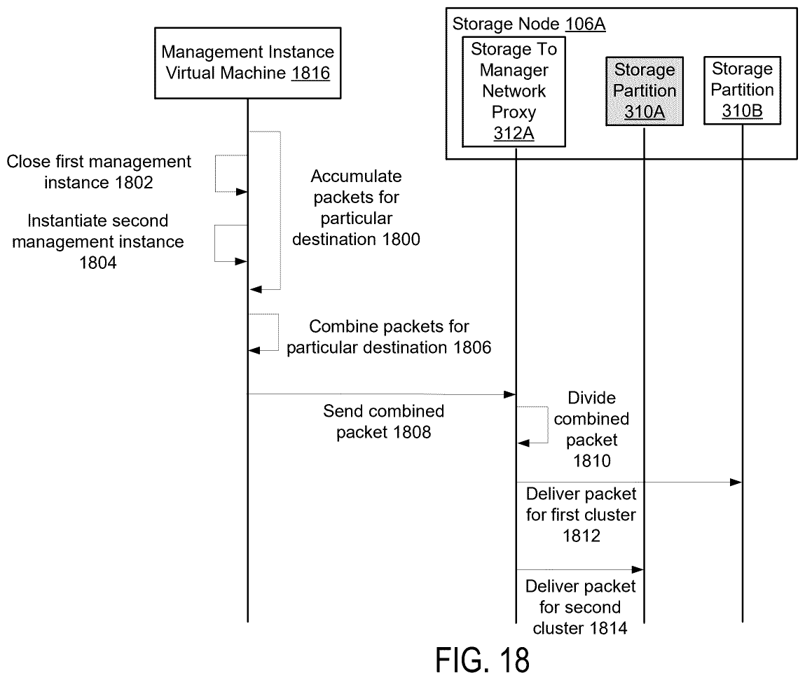

FIG. 18 illustrates actions of components of a distributed database system to generate and send multi-client combined packets, according to some embodiments.

At 1800, a management instance virtual machine 1816 may accumulate packets, which may share a particular destination storage node 106. A management instance virtual machine 1816 may be a virtual machine which primarily hosts management instances for a distributed database. At 1802, the management instance virtual machine 1816 may terminate a first management instance that the management instance virtual machine 1816 hosts. At 1804, the management instance virtual machine 1816 may instantiate a second management instance that the management instance virtual machine 1816 hosts. The first and second management instances may generate packets with an intended destination storage node 106A. The first and second management instances may be associated with different clusters and different clients.

At 1806, the management instance virtual machine 1816 may combine packets for the particular destination storage node 106A. At 1808, the management instance virtual machine 1816 may send the combined packet to storage to manager network proxy 312A. At 1810, storage to manager network proxy 312A may divide the combined packet into packets similar to the packets generated by the first management instance and the second management instance. At 1812, storage to manager network proxy 312A may deliver packets associated with a first cluster to a storage partition 310 associated with the first cluster. At 1814, storage to manager network proxy 312A may deliver packets associated with a second cluster to a storage partition associated with the second cluster.

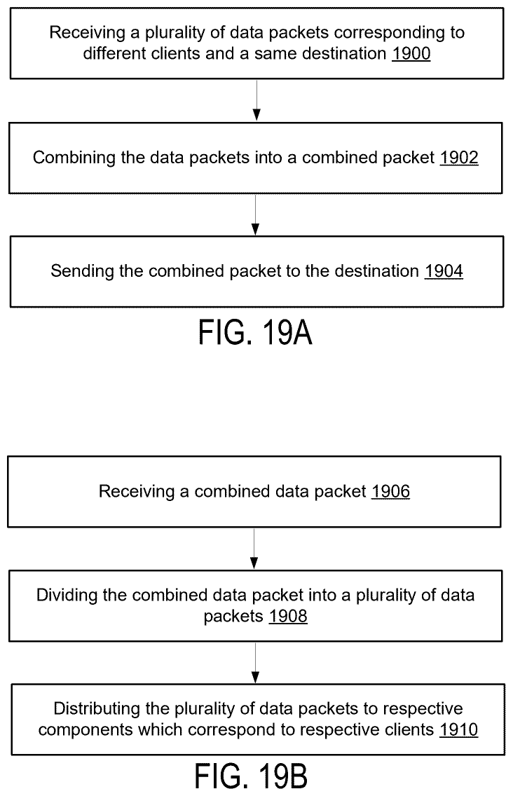

FIG. 19A is a flowchart illustrating a method for generating and sending a multi-client combined packet, according to some embodiments.

At 1900, a sending proxy may receive a plurality of data packets corresponding to different clients which share an intended destination computing device. At 1902, the sending proxy may combine the data packets into a combined packet. At 1904, the sending proxy may send the combined packer to the destination computing device.

FIG. 19B is a flowchart illustrating a method for receiving and processing a multi-client combined data packet, according to some embodiments.

At 1906, a receiving proxy may receive a combined data packet. At 1908, the receiving proxy may divide the combined data packet into a plurality of data packets. The data packets generated as a result of dividing the combined data packet may be similar to the data packets the sending proxy received at 1900, as described in relation to FIG. 19A. At 1910, the receiving proxy may distribute the plurality of data packets to respective components the data packets designate as destination components. The components may correspond to different clients.

### Example Computer System

FIG. 20 is a block diagram illustrating an example computer system that implements some or all of the techniques described herein, according to some embodiments.

FIG. 20 illustrates exemplary computer system 2000 usable to implement the distributed database connectivity system as described above with reference to FIGS. 1-19B. In different embodiments, computer system 2000 may be any of various types of devices, including, but not limited to, a network computer, a mobile device, a consumer device, application server, storage device, a peripheral device such as a switch, modem, router, or in general any type of computing or electronic device.

Various embodiments of program instructions for a distributed database connectivity system, as described herein, may be executed in one or more computer systems 2000, which may interact with various other devices. Note that any component, action, or functionality described above with respect to FIGS. 1-19B may be implemented on one or more computers configured as computer system 2000 of FIG. 20, according to various embodiments. In the illustrated embodiment, computer system 2000 includes one or more processors 2010 coupled to a system memory 2020 via an input/output (I/O) interface 2040. Computer system 2000 further includes a network interface 2050 coupled to I/O interface 2040, and one or more input/output devices 2060. In some cases, it is contemplated that embodiments may be implemented using a single instance of computer system 2000, while in other embodiments multiple such computer systems, or multiple nodes making up computer system 2000, may be configured to host different portions or instances program instructions as described above for various embodiments. For example, in one embodiment some elements of the program instructions may be implemented via one or more nodes of computer system 2000 that are distinct from those nodes implementing other elements.

In some embodiments, computer system 2000 may be implemented as a system on a chip (SoC). For example, in some embodiments, processors 2010, memory 2020, I/O interface 2040 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 2020 may be configured to store compression or decompression program instructions for a distributed database connectivity system 2030 accessible by one or more of the processors 2010. In various embodiments, system memory 2020 may be implemented using any suitable memory technology, such as static random-access memory (SRAM), synchronous dynamic RAM (SDRAM), nonvolatile/Flash-type memory, or any other type of memory. In the illustrated embodiment, program instructions for a distributed database connectivity system 2030 may be configured to implement any of the functionality described above. In some embodiments, program instructions and/or data may be received, sent, or stored upon different types of computer-accessible media or on similar media separate from system memory 2020 or computer system 2000.

In one embodiment, I/O interface 2040 may be configured to coordinate I/O traffic between processor 2010, system memory 2020, and any peripheral devices in the device, including network interface 2050 or other peripheral interfaces, such as input/output devices 2060. In some embodiments, I/O interface 2040 may perform any necessary protocol, timing, or other data transformations to convert data signals from one component (e.g., system memory 2020) into a format suitable for use by another component (e.g., processor 2010). In some embodiments, I/O interface 2040 may include support for devices attached through various types of peripheral buses, such as a variant of the Peripheral Component Interconnect (PCI) bus standard or the Universal Serial Bus (USB) standard, for example. In some embodiments, the function of I/O interface 2040 may be split into two or more separate components, such as a north bridge and a south bridge, for example. Also, in some embodiments, some or all of the functionality of I/O interface 2040, such as an interface to system memory 2020, may be incorporated directly into processor 2010.

Network interface 2050 may be configured to allow data to be exchanged between computer system 2000 and other devices attached to a network 2070 (e.g., carrier or agent devices) or between nodes of computer system 2000. Network 2070 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 2050 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 2060 may, in some embodiments, include one or more display terminals, keyboards, keypads, touchpads, scanning devices, voice or optical recognition devices, or any other devices suitable for entering or accessing data by one or more computer systems 2000. Multiple input/output devices 2060 may be present in computer system 2000 or may be distributed on various nodes of computer system 2000. In some embodiments, similar input/output devices may be separate from computer system 2000 and may interact with one or more nodes of computer system 2000 through a wired or wireless connection, such as over network interface 2050.

As shown in FIG. 20, memory 2020 may include program instructions for a distributed database connectivity system 2030, which may be processor-executable to implement any element or action described above. In one embodiment, the program instructions may implement the methods described above. In other embodiments, different elements and data may be included.

Computer system 2000 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to computer system 2000 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a first computing device hosting a plurality of virtual machines implementing a plurality of management instances;
a second computing device hosting a plurality of storage partitions;
wherein to send data packets between the management instances and the storage partitions, a proxy associated with the first computing device is configured to:
receive, from the plurality of management instances, a plurality of data packets which correspond to a plurality of clients, wherein the plurality of data packets have respective intended destinations at respective ones of the plurality of storage partitions;
combine the plurality of data packets into a single combined data packet; and
send the single combined data packet to a second proxy associated with the second computing device.

2. The system of claim 1, wherein the second proxy is configured to divide the single combined data packet into the plurality of data packets.

3. The system of claim 1, wherein the single combined data packet comprises:
a packet header which identifies the second proxy as a target destination for the single combined data packet; and
a payload comprising the plurality of data packets and metadata for each of the plurality of data packets which indicates the respective intended destinations of respective ones of the plurality of data packets.

4. The system of claim 3, wherein the metadata comprises an indication of a cluster with which an individual one of the plurality of data packets is associated.

5. The system of claim 1, wherein the single combined data packet is an encapsulated data packet comprising the plurality of data packets.

6. The system of claim 1, wherein the single combined data packet is an unencapsulated data packet comprising the data included in the plurality of data packets.

7. A method, comprising:
receiving, from a plurality of sending components of a distributed database which are hosted on one or more computing devices, a plurality of data packets which correspond to a plurality of clients, wherein the plurality of data packets have respective intended destinations of respective receiving components of the distributed database which are hosted on the one or more computing devices;
combining the plurality of data packets into a single combined data packet; and
sending the single combined data packet to the receiving components.

8. The method of claim 7, wherein said sending the single combined data packet is performed by a first proxy for the one or more computing devices, and a second proxy for the one or more computing devices receives the single combined data packet.

9. The method of claim 8, wherein the single combined data packet is divided at the second proxy into the plurality of data packets.

10. The method of claim 8, wherein the single combined data packet comprises:
a packet header which identifies the second proxy as a target destination for the single combined data packet; and
a payload comprising the plurality of data packets and metadata for each of the plurality of data packets which indicates the respective intended destinations of the plurality of data packets.

11. The method of claim 10, wherein the metadata comprises an indication of a cluster with which an individual one of the plurality of data packets is associated.

12. The method of claim 7, wherein the single combined data packet is an encapsulated data packet comprising the plurality of data packets.

13. The method of claim 7, wherein the single combined data packet is an unencapsulated data packet comprising the data included in the plurality of data packets.

14. A non-transitory storage medium storing program instructions that, when executed on or across one or more processors, cause the one or more processors to:
receive, from a plurality of sending components of a distributed database which are hosted on one or more computing devices, a plurality of data packets which correspond to a plurality of clients, wherein the plurality of data packets have respective intended destinations of respective receiving components of the distributed database which are hosted on the one or more computing devices;
combine the plurality of data packets into a single combined data packet; and
send the single combined data packet to the receiving components.

15. The non-transitory storage media of claim 14, wherein said sending the single combined data packet is performed by a first proxy for the one or more computing devices, and a second proxy for the one or more computing devices receives the single combined data packet.

16. The non-transitory storage media of claim 15, wherein the single combined data packet is divided at the second proxy into the plurality of data packets.

17. The non-transitory storage media of claim 15, wherein the single combined data packet comprises:
a packet header which identifies the second proxy as a target destination for the single combined data packet; and
a payload comprising the plurality of data packets and metadata for each of the plurality of data packets which indicates the respective intended destinations of the plurality of data packets.

18. The non-transitory storage media of claim 17, wherein the metadata comprises an indication of a cluster with which an individual one of the plurality of data packets is associated.

19. The non-transitory storage media of claim 14, wherein the single combined data packet is an encapsulated data packet comprising the plurality of data packets.

20. The non-transitory storage media of claim 14, wherein the single combined data packet is an unencapsulated data packet comprising the data included in the plurality of data packets.
